(19) United States
(12) Patent Application Publication
(10) Pub. No.: US 2003/0009352 A1
(43) Pub. Date: Jan. 9, 2003

(54) Interpreter certification system

(76) Inventors: Andy Bolotinikov, Pacific Grove, CA (US); Danyune Geertsen, Carmel, CA (US); Lara Magnusdottir, Marina, CA (US); Jurgen Suttung, Pacific Grove, CA (US); Lilian Belsky, Klamath Falls, OR (US); Steven Hawson, Deming, NM (US); Lorena Martin, Van Buren, ME (US); Nataly Romero, Mason City, IL (US)

Correspondence Address: STONEMAN LAW OFFICES, LTD, 3113 NORTH 3RD STREET, PHOENIX, AZ, 85012, US

(21) Appl. No.: 10/167,536

(22) Filed: Jun. 11, 2002

Related U.S. Application Data
(60) Provisional application No. 60/298,848, filed on Jun. 15, 2001.

(51) Int. Cl. G06F 17/60

(52) U.S. Cl. 705/1

(57) ABSTRACT

A method for testing and certifying interpreter's knowledge in specific industries and language pairs. Certification is accomplished through testing, training, service observation and customer feedback. Certification testing is conducted using tests developed for a specific industry and language pair. Testing is conducted telephonically strictly adhering to a fixed protocol. Test scoring is accomplished using a dictionary of terms for each industry and language pair which indicates level of accuracy for each possible interpretation.

### CROSS-REFERENCE TO RELATED APPLICATION

The present application is related to applicant's prior U.S. Provisional Application No. 60/298,848, filed Jun. 15, 2001, entitled “INTERPRETER CERTIFICATION SYSTEM”, the contents of all of which are hereby herein incorporated by reference and are not admitted to be prior art with respect to the present invention by their mention in this cross-reference section.

### BACKGROUND

This invention relates to certification methods for interpreters, particularly, for oral-consecutive interpretation (as by telephone), and particularly, for specialty fields (such as medical, insurance or courts of law).

Throughout the past decade, there has been a steady increase in usage of interpretation services in the U.S., particularly, in the legal and health care fields. This is an indication of progress toward providing quality service and equal access to all. At the same time, organizations using interpreters have become more sophisticated and demand higher quality service. Currently, there are only a few certification programs available in the interpretation field in the United States. Court Interpretation Certification is offered by the Federal court, Consortium states courts, and California courts; and Medical Interpretation Certification is offered by Washington State. Other states, such as Minnesota and Massachusetts, have begun to identify standards of practice for medical interpreters and to develop medical interpreter certification processes. Limited certification entities and limited languages available for certification make it difficult for the consumers to access a certified interpreter.

Furthermore, there have been no national standards for measurement of interpretation skills in specific fields such as medicine, the courts, or insurance. If such standards could be set, customers might be better able to find and use interpreters with skills that match the customer requirements, thus, providing better service to customers in these fields. It is still a common practice by many service providers to determine interpreters' competence on an ad hoc basis. For some organizations, there has been no evaluation process at all. In the past, interpreters have been commonly selected according to availability, instead of skills. Even where training and quality control took place, there was no system to allow the selection of interpreters with matching special skills for pertinent customers.

### OBJECTS OF THE INVENTION

According to the embodiments of the invention described herein, it is an object and feature of the present invention to overcome the above-mentioned, and other problems and difficulties of the prior art.

It is an object and feature of one aspect of this invention to create a method and model of certification that aims at providing interpreters with skills that match the customer requirements. It is a further object and feature of an aspect of this invention, through testing, training, service observation and customer feedback components, to identify and certify interpreters with knowledge in specific fields or industries so they may provide better service to customers in these fields. And it is an object and feature of an aspect of this invention to set the standard for the over-the-phone interpretation industry that has no existing standards, and to verify interpreters' competence required for selected industries, and therefore, match the interpreter's skill sets with the customer's requirements.

It is yet another object and feature of an aspect of this invention to provide a method of doing business which provides a general method for certifying telephonic (or, broadly, oral-consecutive) interpreters for use in specialty areas, areas where the terminology is industry-specific. And, it is a further object and feature of an aspect of this invention to provide such a method which includes measurable and identifiable ways to independently judge interpreter qualifications for certification in areas comprising at least initial screening, orientation learning, industry-specific training, industry-specific terminology, service observation, and customer satisfaction feedback. And, it is also an object and feature of an aspect of this invention to provide such a method which includes elements of finding skilled interpreters, measuring to find the most typical “core” interpretation scenarios (for use in testing design), doing test design using primarily “core” scenarios (with a plurality of versions so that re-testing, etc., may be accomplished), and testing an interpreter's abilities to use such specialty terminology in actual interpreter use (simulated). And it is an object and feature of an aspect of this invention to provide such a method, which includes measuring continuing proficiency of a certified or certifiable interpreter in actual service.

It is also an object and feature of an aspect of this invention to provide such a method which includes providing interpreter tests (preferably in multiple versions), which include as scoring elements, first-language terms (to be interpreted into a second language) used in the specialty field to be certified. Further, it is an object and feature of an aspect of this invention to provide such a method which includes grading such testing with at least one “intermediate” scoring level scoring (not just correct or incorrect). And it is an object and feature of an aspect of this invention to provide such a method which includes providing, preferably for each test version, an associated scoring dictionary which lists, for grading purposes, essentially each term in such test to be interpreted and which interpretations are entitled to which scoring. And it is further an object and feature of an aspect of this invention to provide such a method which includes providing a system for continuous updating of such scoring dictionaries by adding to them such interpretations as are made by test-takers (which are not obviously totally incorrect), along with the score to be in the future consistently given to test-takers, as with the other previous dictionary entries.

And it is a feature of this invention to provide each and every feature, advantage, business method and computer system described, mentioned or suggested anywhere in this provisional application, including all tables, figures, appendices (entirely incorporated herein by reference) and other material therein, especially including the within invention Summary.

### SUMMARY

According to a preferred embodiment of the present invention, this invention provides an interpreter certification process for achieving a defined interpretation competency level in language pairs in industry-specific settings comprising the steps of: selecting interpreters by evaluating language proficiencies and interpretation skills of at least one interpreter candidate in at least one language pair; training at least one such selected interpreter in procedural standards of at least: interpretation, customer service, ethics, and call handling for different industries; training such at least one interpreter in industry-specific terminology in at least one such language pair; setting required minimum competency levels for certification in such at least one language pair in such at least one specific industry; and selecting at least one certified interpreter by testing such at least one interpreter for minimum competency in interpretation in such at least one language pair in such at least one industry-specific setting.

Moreover, this invention provides such a process further comprising the steps of: documenting such at least one certified interpreter's interpretation performance on at least one interpretation assignment for at least one customer; and documenting such at least one customer's satisfaction level with interpretation performance of such at least one certified interpreter.

It also provides such a method in which: interpretation is oral consecutive telephone-based interpretation. Additionally, it provides a method in which: the specific industry is healthcare. Furthermore, it provides a method in which: the specific industry is federal, state and local courts. Also, it provides a method in which: the specific industry is insurance.

According to a preferred embodiment of the present invention, this invention provides a test-development method for creating at least one interpretation test to measure interpreter competency in language pairs in industry-specific settings, comprising the steps of: defining of at least one objective for such at least one interpretation test; identifying most-likely interpretation scenarios by surveying actual interpretation instances in at least one industry-specific setting in at least one language pair; identifying most-likely interpretation scenarios by interviewing at least one expert in such at least one industry-specific setting for interpretation in such at least one language pair; from such identifications of such most-likely interpretation scenarios, developing, for more uniform scoring, at least one dictionary comprising scoring units providing for essentially each proposed-test source language term a plurality of target language interpretation terms in such at least one industry-specific setting in such at least one language pair; classifying each such target language interpretation term among a desired number of scoring categories based on relative level of interpretation accuracy; constructing, for such at least one language pair, such at least one interpretation test comprising verbal scenarios containing at least a plurality of such source language terms to be interpreted into such target language; administering such at least one interpretation test to a plurality of interpreters; scoring such at least one interpretation test for each such plurality of interpreters using such dictionary comprising scoring units; and for at least each particular target language response on each such at least one interpretation test calling for a non-zero scoring unit and not listed in such dictionary comprising scoring units, determining an appropriate such scoring category to be assigned to such particular response and adding such particular response and category assignment to such dictionary comprising scoring units.

Moreover, it also provides such a method wherein such step of, for at least each particular target language response on each such at least one interpretation test calling for a non-zero scoring unit and not listed in such dictionary comprising scoring units, determining an appropriate such scoring category to be assigned to such particular response and adding such particular response and category assignment to such dictionary comprising scoring units, comprises the steps of: assigning at least one expert in such language pair in such industry-specific setting comprising such interpretation test to classify each such target language response not listed in such dictionary comprising scoring units into an appropriate such scoring category based on relative level of interpretation accuracy; and including such classified target language response and such appropriate scoring category in at least one updated version of such dictionary comprising scoring units.

Furthermore, it also provides such a method further comprising the step of setting a respective scoring value for each respective such scoring category. Additionally, it provides a method wherein such step of, setting a respective scoring value for each respective such scoring category comprises, the steps of: setting a scoring value of two to “most accurate” level of interpretation accuracy; setting a scoring value of one to “accurate” level of interpretation accuracy; and setting a scoring value of zero to “least accurate” level of interpretation accuracy. Also, it provides a method wherein such step of, scoring such interpretation test for each such plurality of interpreters using such dictionary comprising scoring units, comprises the steps of: summing a total of such scoring values for each such interpreter for each administration of such interpretation test; and presenting such total as a percentage score. Additionally, it provides method further comprising the step of: appointing a team for overseeing development of such interpretation test, wherein such team comprises at least one appointed participant; wherein such at least one appointed participant has recognized expertise in a particular language pair in a particular industry-specific setting; and wherein such appointing is based at least on education and experience. In addition, it provides a method further comprising the steps of: training test administrators using at least one such interpretation test, at least one test administration guideline, and at least one test examiner guideline; and validating proficiency measurements for such interpretation test.

Furthermore, it provides a method in which: interpretation is oral consecutive telephone-based interpretation. And it provides a method wherein: such at least one interpretation test is bi-directional. Also, it provides a method wherein: such at least one interpretation test is uni-directional. Additionally, it provides a method in which the specific industry is healthcare. Moreover, it also provides a method in which: the specific industry is federal, state and local courts. And it provides a method in which: the specific industry is insurance.

According to a preferred embodiment of the present invention, this invention provides a method for administering interpretation tests to interpreters to measure interpreter competency in language pairs in industry-specific settings comprising the steps of: conducting such interpretation tests via telephone with at least one interpreter by at least one test administrator; recording each at least one test source language statement comprising at least one scoring unit by such test administrator and each at least one corresponding target language response by such interpreter; referencing at least one dictionary comprising such scoring units for each such at least one scoring unit contained within such each at least one test source language statement by such test administrator to determine interpretation accuracy of at least one such scoring unit of such each at least one corresponding target language response by such interpreter; assigning at least one scoring value for such each at least scoring unit of such at least one corresponding target language response by such interpreter to reflect such determined interpretation accuracy; summing a total of any such scoring values for each such interpreter for each administration of each such interpretation test; assigning such total as a raw score; and determining such interpreter competency selected essentially from “Meets Standard”, “Borderline Meets Standard”, “Does Not Meet Standard” by comparing such raw score to defined competency score ranges for each such language pair in each such industry-specific setting.

Furthermore, this invention also provides a method further comprising the step of: notifying such interpreter of such competency determination. And this invention provides a method further comprising the steps of: preparing at least one additional version of such interpretation test to assist preventing pre-knowledge of such interpretation test content by at least one such interpreter; administering such at least one additional version of such interpretation test to interpreters of equivalent skill; noting differences between such additional versions by comparing results of such administrations; and revising such at least one additional version of such interpretation test to achieve essentially comparable measurement of competency. Additionally, it provides a method further comprising the step of: for at least each particular target language scoring unit on each such interpretation test calling for a non-zero scoring unit and not listed in such dictionary comprising scoring units, determining an appropriate such scoring value to be assigned to such particular target language scoring unit and adding such particular target language scoring unit and such scoring value to such dictionary comprising scoring units. In addition, it provides a method further comprising the steps of: assigning at least one expert in such language pair in such industry-specific setting comprising such interpretation test to classify each such target language response not listed in such dictionary comprising scoring units into an appropriate such scoring unit based on relative level of interpretation accuracy; and including such classified target language response and such appropriate scoring unit in at least one updated version of such dictionary comprising scoring units.

Furthermore this invention also provides a method in which interpretation is oral consecutive telephone-based interpretation. And this invention provides a method in which administration of at least one such interpretation test is by strict adherence to a fixed test administration protocol for at least one such interpretation test. Also, it provides a method wherein such at least one interpretation test is bi-directional. Moreover, it provides a method wherein such at least one interpretation test is uni-directional. Also, it provides a method in which the specific industry is healthcare. And it provides a method in which the specific industry is federal, state and local courts. Furthermore, it provides a method in which the specific industry is insurance.

According to a preferred embodiment of the present invention, this invention provides a method for providing interpretation competency testing services by a business testing at least one customer's actual or potential at least one employee-interpreter (term herein after used for all such staff: employee bilingual staff, employee or temporary staff interpreters, contracted agency interpreters, or volunteer (non employee) interpreters) comprising the steps of: conducting such interpretation competency testing via telephone with such at least one employee-interpreter by at least one test administrator of such business using at least one interpreter skills test; recording each at least one test source language statement from such interpreter skills test by such test administrator and each at least one corresponding target language response by such employee-interpreter; referencing at least one dictionary comprising scoring units for each such at least one scoring unit contained within such each at least one test source language statement by such test administrator to determine interpretation accuracy of such each at least one corresponding target language response by such employee-interpreter; assigning at least one scoring value for each such target language response by such employee-interpreter reflecting such determined terminology interpretation accuracy; summing a total of such scoring values for each such employee-interpreter for each administration of such interpretation test; calculating at least one terminology score reflecting such employee-interpreter's knowledge of industry-specific terminology; determining language proficiency level of such employee-interpreter by evaluating responses by such employee-interpreter; determining communicative skill level of such employee-interpreters by evaluating responses by such employee-interpreters; assigning at least one subjective score considering such language proficiency level and such communicative skill level demonstrated by such employee-interpreter; and determining such employee-interpreter competency by considering, in combination, such terminology score and subjective score of such employee-interpreter.

Moreover, the invention also provides a method further comprising the steps of: contracting with each such customer to provide interpretation competency testing to each such employee-interpreter of such customer; enrolling such customer's employee-interpreters for administration of such interpretation competency testing on a particular date and time; and notifying such employee-interpreter and such customer of such competency determination. Additionally, it provides a method which the scoring unit values may be 0, 1 or 2. And it provides a method in which interpretation is oral consecutive telephone-based interpretation. Also, it provides a method wherein such at least one interpretation test is bi-directional. Further, it also provides a method wherein such at least one interpretation test is uni-directional. Also, it provides a method in which the specific industry is healthcare. And it provides a method in which the specific industry is federal, state and local courts. Additionally, it provides a method in which the specific industry is insurance.

According to a preferred embodiment of the present invention, this invention provides a dictionary for scoring of interpretation tests for at least one language pair in at least one industry-specific setting comprising: scoring units structured and arranged to provide, for essentially each source language term of at least one such interpretation test, a plurality of target language interpretation terms in such at least one language pair in such at least one industry-specific setting; and classifications of each such target language interpretation term among a desired number of scoring categories based on determined level of interpretation accuracy. Furthermore, it also provides a dictionary wherein such scoring units are determined from identifications of most-likely interpretation scenarios in such at least one language pair in such at least one industry-specific setting. Additionally, it provides a dictionary wherein such scoring categories comprise at least three levels of scoring values of course under the appropriate circumstances, two scorings might be appropriate). Moreover, it also provides a dictionary wherein such scoring categories comprise assigned scoring values of: two to “most accurate” level of interpretation accuracy; one to “accurate” level of interpretation accuracy; and zero to “least accurate” level of interpretation accuracy. And it provides a dictionary in which such interpretation test is oral consecutive telephone-based interpretation test. Also it provides a dictionary in which the specific industry is healthcare. Furthermore it provides a dictionary in which the specific industry is federal, state and local courts. Finally, it also provides a dictionary in which the specific industry is insurance.

### DEFINITIONS, ACRONYMS AND CROSS-REFERENCES

Bi-directional—This term is sometimes used herein to refer to situations in which interpretation is performed between both languages of a language pair.

Communicative Skills—This term is sometimes used herein to refer to interpreter's skill at: following instructions and keeping within the role of interpreter; minimizing omissions and additions; clear and timely clarifications; appropriate speed and pace; minimum number of repetitions; minimizing dictionary checks; adequate preparation and resourcefulness; proper use of formal vs. informal address (some languages); using a polite and pleasant voice and tone; demonstrating overall clarity; demonstrating motivation and aptitude; and customer service.

Customer employees—This term is sometimes used herein to refer to interpreters or bilingual staff employed or contracted by applicant's customers.

Employee-interpreter—This term is sometimes used herein to refer to employee bilingual staff, employee or temporary staff interpreters, contracted agency interpreters, or volunteer (non employee) interpreters.

Interpret—This term is sometimes used herein to refer to listening to a speaker in one language, analyzing the message and accurately conveying its original meaning to a listener in a different language. Interpreters do not interpret word-for-word, but meaning-for-meaning.

IRC—term is sometimes used herein to refer to applicant's Interpreter Response Center.

Language pair—This term is sometimes used herein to refer to a combination of two languages (such as English and Spanish) in which an interpreter relays information back and forth.

Language Proficiency—This term is sometimes used herein to refer to interpreter skill in both languages of a language pair for: pronunciation; grammar (syntax and usage); and knowledge of vocabulary, other than industry-specific terminology.

Scoring unit—This term is sometimes used herein to refer to a specified word, term or phrase of a source language and the expected target language responses used to objectively evaluate an interpreter's proficiency in a language pair in an industry-specific setting. Interpreter's responses in the target language for each source language term are then used to evaluate the accuracy of interpretation. Each specific target language interpretation in a scoring unit is assigned a scoring weight of 2, 1, or 0 reflecting the accuracy of interpretation.

Significant Errors—This term is sometimes used herein to refer to errors of omission, addition, editorializing or misinformation (black and white errors) that seriously change the meaning of the statement in a source language. Candidates may have no more than three significant errors if they are to pass the Interpreter Skills Test.

Source language—This term is sometimes used herein to refer to the language from which an interpretation is derived.

Subjective Score—This term is sometimes used herein to refer to a rating of interpreter skill represented by a scale from 1 to 5, with 1 as the lowest and 5 as the highest score possible. 1)—The interpreter has serious problems with delivery. Candidates receiving this score will not pass the Interpreter Skills Test regardless of their performance in other areas of the test. 2)—The interpreter is experiencing difficulty in several of the rating items. Candidates receiving this rating will only pass the Interpreter Skills Test if they have a terminology score over 95% and no significant errors. 3)—The interpreter's language proficiency and communicative skills are at an average level. The minimum subjective rating for a passing score is 3. 4)—The interpreter demonstrates good language proficiency and communicative skills. Candidates receiving this rating will pass the Interpreter Skills Test unless their terminology score is less than 75% and/or they have more than 3 significant errors. 5)—The interpreter demonstrates superior language proficiency and communicative skills. Candidates will pass the Interpreter Skills Test unless they have a terminology score of less than 75% and/or more than 3 significant errors.

Target Language—This term is sometimes used herein to refer to the language into which an interpretation is done.

Terminology Score—This term is sometimes used herein to refer to the measurement of the candidate's knowledge of industry-specific terminology and is expressed as a percentage. There are a total of 50 terms tested on each Interpreter Skills Test. Candidates have one point subtracted for each term they either say incorrectly or omit.

Translate—This term is sometimes used herein to refer to evaluating every word and concept for both cultural and linguistic nuances in a written document in one language and accurately conveying the meaning in a second document in different language. Translations convey meaning-for-meaning rather than word-for-word exchanges.

Uni-directional—This term is sometimes used herein to refer to situations in which interpretation is done for only one language of a language pair, from only one source language instead of two. For example, for the language pair Hmong and English translation is only done from Hmong to English.

### BRIEF DESCRIPTION OF THE DRAWINGS

FIG. 1 illustrates the relationship of the three primary areas involved in interpreter certification according to a preferred embodiment of the present invention.

FIG. 2 illustrates the components of certification according to the preferred model and method of the present invention, showing both the six elements thereof described in this specification and the three areas into which such elements fall.

FIG. 3 illustrates the certification component sequence used to achieve ongoing certification of interpreters, according to a preferred embodiment of the current invention.

FIG. 4 illustrates applicant's preferred method of providing interpretation services to its customers, according to a preferred embodiment of the current invention.

FIG. 5 illustrates applicant's preferred method of conducting interpreter candidate Specific Certification Testing, according to a preferred embodiment of the current invention.

FIG. 6 illustrates the manner in which industry specific certification tests are developed, according to a preferred embodiment of the present invention, according to a preferred embodiment of the current invention.

FIG. 7 illustrates a collection of information from interpreter feedback of the type preferably used according to the present invention in assessing what the most typical scenarios are in interpreting in the selected industry (in this case, medical).

FIG. 8 illustrates a sample medical certification exam, abbreviated, but of a preferred type, according to a preferred embodiment of the current invention.

FIG. 9 illustrates a sample dictionary for the Spanish-to-English scoring units of the sample test of FIG. 8, abbreviated, but of a preferred type, according to a preferred embodiment of the current invention.

FIG. 10 illustrates a sample dictionary for the English-to-Spanish scoring units of the sample test of FIG. 8, abbreviated, but of a preferred type, according to a preferred embodiment of the current invention.

FIG. 11 illustrates a sample scoring sheet preferably used by the examiner for the sample test of FIG. 8, abbreviated, but of a preferred type, according to a preferred embodiment of the current invention.

FIG. 12 illustrates, as an example, for a selected test version, a table comparing and associating an examinee's raw score (from scored scoring units of the test) with that examinee's percentage score—for a case in which the examinee met the certification standard, according to a preferred embodiment of the current invention.

FIG. 13 illustrates, as an example, for a selected test version, a table comparing and associating an examinee's raw score (from scored scoring units of the test) with that examinee's percentage score—for “borderline” cases in which the examinee would preferably be entitled to a re-scoring, according to a preferred embodiment of the current invention.

FIG. 14 illustrates, as an example, for a selected test version, a table comparing and associating an examinee's raw score (from scored scoring units of the test) with that examinee's percentage score—for a case in which the examinee did not meet the certification standard, according to a preferred embodiment of the current invention.

FIG. 15 illustrates the business method followed by applicant for providing interpretation training, testing and certification to customer's employee-interpreters, according to a preferred embodiment of the current invention.

FIG. 16 illustrates the recommend scoring guidelines used for interpreter skills tests, according to a preferred embodiment of the current invention.

FIG. 17 illustrates the summary score sheet provided by applicant to interpreter at the completion of the interpreter skills test, according to a preferred embodiment of the current invention.

### DETAILED DESCRIPTION OF PREFERRED EMBODIMENTS OF THE INVENTION

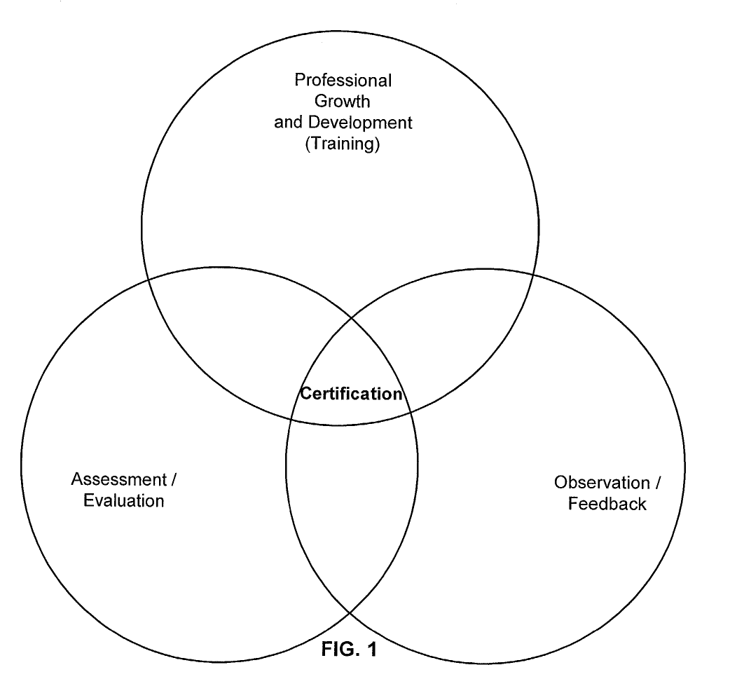

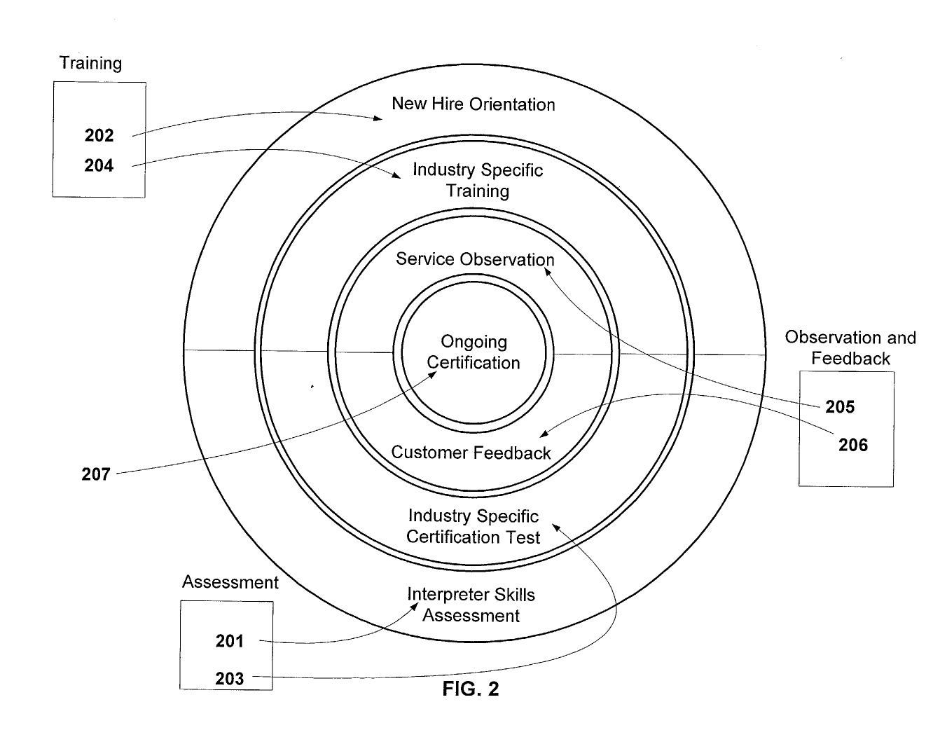

According to a preferred embodiment hereof, applicant's Certification Program is designed to be holistic and performance-based, encompassing three areas: training, observation/feedback, and assessment. As shown in FIG. 1, these three areas are inter-related and operate together to ensure reliable competency certification. Preferably, the three areas are further divided into six components. Applicant's certification program preferably requires proof of proficiency in each of the six components and is a significant departure from existing certification processes, which rely on only one component. As shown in FIG. 2, the six components of applicant's Certification Programs preferably include: 1) Interpreter Skills Assessment 201; 2) New Hire Orientation Training 202; 3) Industry Specific Certification Testing 203; 4) Industry Specific Training 204; 5) Service Observation 205; and 6) Customer Feedback 206. Also as shown in FIG. 2, preferably, New Hire Orientation 202 and Industry Specific Training 204 comprise the training area; Service Observation 205 and Customer Feedback 206 comprise the observation and feedback area; and Interpreter Skills Assessment 201 and Industry Specific Certification Testing 203 comprise the assessment area of applicant's certification program. Ongoing Certification 207 is the outcome of successful completion of each of these Certification Program Components.

Each of these components may preferably be more specifically described as follows:

1) The interpreter must pass the Interpreter Skills Assessment (ISA) 201, an initial screening exam that evaluates an interpreter's language and interpretation skills, using a role-play format with scenarios typical of calls taken by applicant's Interpreters.

2) The interpreter must complete the New Hire Orientation Training 202 program, in which participants learn about interpreting methods and procedures, customer service standards, and the Professional Code of Ethics. Each interpreter is required to adhere to standards of professionalism by signing the Confidentiality and Non-Disclosure Agreement. The Interpreter also learns standards of call handling for different industries during the process.

3) The interpreter must complete the Industry-Specific Training 204, satisfactorily completing all training sessions in specific industries for his/her language specialty.

4) The interpreter must complete the Industry-Specific Certification Test 203, obtaining a passing score on an oral-consecutive interpretation exam specifically designed for the given industry and language specialty.

5) The interpreter must fulfill the Service Observation 205 requirement, which encompasses meeting performance standards through observation by Quality Specialists and/or Senior Language Specialists.

6) The interpreter must meet the Customer Feedback 206 requirement, which assures that the interpreter has a record of satisfactory customer feedback.

This multifaceted model is based upon applicant's belief that a complete assessment of an interpreter's proficiency requires more than a single form of evaluation. Real world situations requiring language interpretation are likely to be affected by a number of factors, and nearly always each interpretation setting will be unique. Recognizing the unique nature of each performance of interpreting, the present invention examines diverse domains to measure interpreter competency. Further, through the use of both skills assessments and performance-based evaluation criteria, it is possible to achieve testing criteria that very closely approximate real world interpretation settings and demands, permitting precise measurements for certification and cross-comparison of language interpretation skills.

The above provided list of six components (see also FIG. 2), is unique to applicant's certification process, setting applicant's certification system apart as distinctively different from any other certification program in existence. Further distinguishing applicant's process from other certification programs, the six identified components of applicant's process are preferably sub-grouped into three distinct categories—Training, Skills Assessment, and Performance Review. Only after each of these six components has been fulfilled, reviewed and deemed satisfactory, will the interpreter candidate be considered and remain duly certified under applicant's certification system.

In application, many of these components are ongoing components, or components that may be undertaken or evaluated in parallel. However, to better understand applicant's system, it is convenient to subcategorize each of these components as follows.

Training

New Hire Orientation Training 202 is preferably the first component of this sub-category. Applicant has developed a program which new interpreters attend. Preferably, this training program is conducted and attended entirely over the phone, thereby permitting wide availability to attendees at a minimal cost and without associated disruptions in schedules associated with travel. These sessions, preferably held over the phone, include an in-depth review of the applicant's code of ethics, as well as both the general and industry-specific interpreting protocols. Preferably, new interpreter candidates seeking certification will sufficiently absorb and synthesize applicant's described methodologies and so more rapidly understand the process of certification as well as the job requirements as an interpreter. Additionally, new hires are observed and mentored by senior interpreters throughout their orientation period.

Industry Specific Training 204 is preferably the second component of this sub-category. Applicant, working in connection with leading professionals in a number of industries (including by way of example, Law, Medicine, and Insurance), has developed industry-specific training programs. The training sessions are preferably held over a number of weeks, and interpreters are preferably paid to attend. Satisfactory completion of the Industry Specific Training is preferably required for full certification. Interpreters seeking certification under applicant's preferred system preferably receive a variety of supporting materials, such as, but certainly not limited to, audio and videocassettes, glossaries, dictionaries, and training manuals. Preferably, at least one experienced facilitator with in-depth knowledge of the subject matter conducts all training sessions.

Assessment

Interpreter Skills Assessment 201 is preferably the first component of this sub-category. Successful performance on an in-language oral proficiency interview and/or the interpreter skills assessment is an evaluation requirement and necessary before certification in an industry-specific area can be achieved. These assessments are preferably administered by applicant, The American Council on the Teaching of Foreign Languages, or other qualified evaluating bodies.

Industry Specific Certification Testing 203 is preferably the second component of this sub-category. In accordance with the system herein disclosed, applicant has developed a sophisticated test permitting precise evaluation and measurement of the interpreting skills held by an interpreter seeking certification for his/her language in a specific field such as medicine, the courts or insurance. The process and methodology applied in the creation and grading of these tests is discussed below. To qualify for industry-specific certification under applicant's preferred system, the interpreter candidate must achieve a passing score on applicant's industry-specific test.

Observation/Feedback

Service Observation 205 is preferably the first component of this sub-category. As taught by applicant's system, certification of an interpreter is not a static issue measured and evaluated at only one point in time. Rather, ongoing service observation for all interpreters is preferably a requirement of both the certification and the service observation programs. A qualified senior interpreter, known as a Senior Language Specialist or a Quality Specialist, evaluates interpreter performance using real-time observation. Interpreters must consistently meet the standards set forth by applicant. Only interpreters who consistently meet the standards are considered to have met this requirement, and thereby, continue to carry applicant's certification.

Customer Feedback 206 is preferably the second requirement of this sub-category. To be considered eligible for certification, and especially ongoing certification, the interpreter should not have any verified customer complaints for the industry in question. More specifically, it is understood by those skilled in the art of interpretation that different words may be more or less effective in communicating precisely between languages. Additionally, professionalism and respect are integral elements in providing interpretation services. An interpreter who has failed to perform in accordance with the policies and procedures set forth by applicant's system is preferably not an interpreter who shall remain certified.

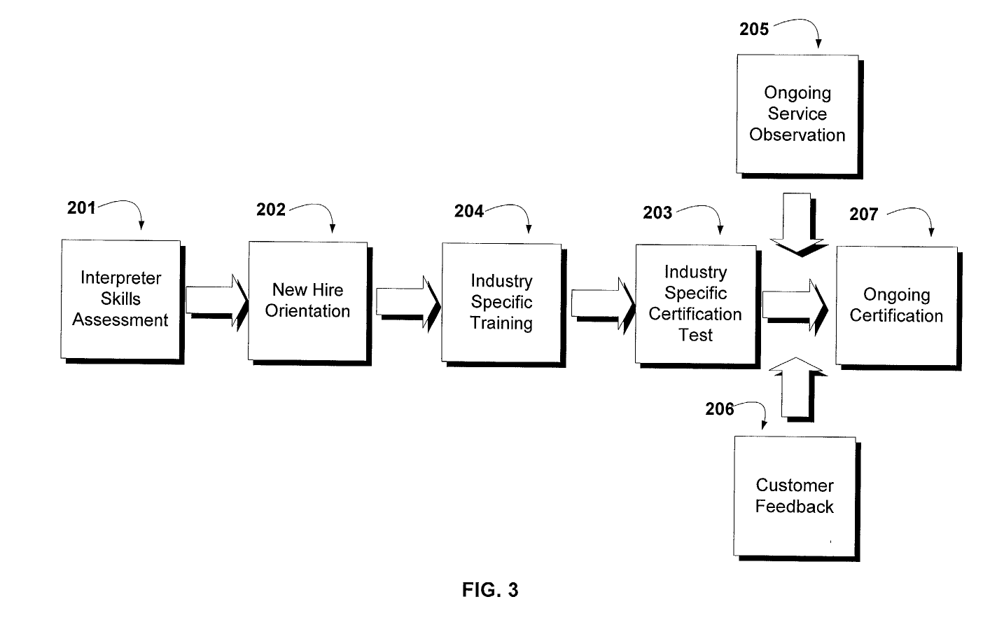

Preferably, as shown in FIG. 3, each of these components is encountered by interpreter candidates in the following order: i) Interpreter Skills Assessment 201; ii) New Hire Orientation Training 202; iii) Industry Specific Certification Training 204; iv) Industry Specific Testing 204. Service Observation 205 and Customer Feedback 206 are ongoing components. This arrangement embodies herein steps of: selecting interpreters by evaluating language proficiencies and interpretation skills of at least one interpreter candidate in at least one language pair; training at least one such selected interpreter in procedural standards of at least: interpretation, customer service, ethics, and call handling for different industries; training such at least one interpreter in industry-specific terminology in at least one such language pair; setting required minimum competency levels for certification in such at least one language pair in such at least one specific industry; and selecting at least one certified interpreter by testing in such at least one language pair in such at least one industry-specific setting. This arrangement embodies herein the steps of: documenting such at least one certified interpreter's interpretation performance on at least one interpretation assignment for at least one customer; and documenting such at least one customer's satisfaction level with interpretation performance of such at least one certified interpreter.

To further acknowledge the status attained by a successful interpreter candidate, a certificate is then issued to the interpreter with the signature from the Certification Manager and the Director of Operations and Training. As taught by applicant, the Certification Manager and Director of Operations and Training are preferably responsible for reviewing and assuring compliance with the applicant's certification procedures. By maintaining diligent adherence to the certification requirements, applicant's system is preferably capable of certifying interpreters with precise measurement of interpreting capability. Such consistency in certification is most desirable in the commercial markets requiring interpreting translation services.

Upon achieving the status of certification for a given industry, the interpreter's information, preferably consisting of his or her certification scores, language of certification, and of course, general contact information is entered into applicant's database. It is this database of known and certified interpreters for particular industries and languages that is then provided to a customer seeking applicant's specific language interpretation help. Such granularity of identified skills does not preclude applicant's system and database from effectively providing generalized interpreting services relevant to any industry or setting.

Applicant's certification is distinctly different from any existing certification programs because it is multifaceted and evaluates an interpreter's overall performance. In sharp contrast, other interpreter programs only have one requirement, that of general testing. By preferably incorporating evaluation of multiple components affecting the quality and performance of an interpreter, applicant has achieved a superior system. By preferably incorporating a system of testing that permits evaluation of performance in an industry-specific setting and a true measurement of performance, applicant's testing system is likewise superior to other forms of testing known to exist.

### Overview of Certification Testing

Applicant calls attention to the lack of linguistic equivalents in other languages, and as between languages. Applicant also calls attention to the variety of different near equivalents that may exist in different languages. For example, in English, the statement “her belly hurts”, may be an accurate statement, but it is far from being as informative as “she is experiencing sharp labor pains”, especially when communicating in a medical setting. The simple fact that the condition can be described in many ways within the same language is only magnified when the statement is translated into a different language, which quite likely also permits a variety of phrasings. Frequently, a language may lack a single precise term to precisely convey a certain statement or concept, such as a medical, legal, or technical term. For instance, issues pertaining to managed care—something very unique to the health care system in the United States—often simply cannot be conveyed with one equivalent term in another language.

To achieve precise and effective communication between parties communicating in different languages, it is vital that appropriate linguistic terms and terminology be both understood and commanded by the interpreter performing the interpreting services.

It is therefore preferably necessary to judge interpretations based upon the context of the setting in which they are occurring. For certification purposes, it is further necessary to recognize and achieve a preferred hierarchical ranking of key terms and concepts, which may be involved in industry-specific interpretation settings. Applicant has achieved such preferred hierarchical ranking of terms through the development of individualized scoring dictionaries, per language pair, for industry-specific settings. Specifically, applicant has identified and/or designated key words and/or phrases which applicant has termed “scoring units”. These scoring units are embedded in the sentences provided to the interpreter seeking certification, preferably in an oral testing environment. The interpreter's rendition of the scoring unit into the target language is then evaluated against the scoring unit translations contained in the appropriate scoring dictionary while the other portions of the interpreter's interpretation are not considered. This arrangement embodies herein a method for administering interpretation tests to interpreters to measure interpreter competency in language pairs in industry-specific settings comprising the steps of: conducting such interpretation tests via telephone with at least one interpreter by at least one test administrator; recording each at least one test source language statement comprising at least one scoring unit by such test administrator and each at least one corresponding target language response by such interpreter; referencing at least one dictionary comprising such scoring units for each such at least one scoring unit contained within such each at least one test source language statement by such test administrator to determine interpretation accuracy of at least one such scoring unit of such each at least one corresponding target language response by such interpreter; assigning at least one scoring value for such each at least scoring unit of such at least one corresponding target language response by such interpreter to reflect such determined interpretation accuracy; summing a total of any such scoring values for each such interpreter for each administration of each such interpretation test; assigning such total as a raw score; and determining such interpreter competency selected essentially from “Meets Standard”, “Borderline Meets Standard”, “Does Not Meet Standard” by comparing such raw score to defined competency score ranges for each such language pair in each such industry-specific setting.

Preferably, the interpreting testing is performed in a bi-directional manner, as with English into another language, and vice versa. For each direction of interpretation, appropriate scoring units are embedded to achieve interpretations that are preferably equal. Given the complexity of concepts to be conveyed, with respect to certain languages, such as Tagalog, Hmong, Serbian, Croatian, Bosnian, Somali, and Farsi, it may be preferred to interpret a greater number of scoring units from the source language into the target language, preferably English, and forego a reciprocal translation of English scoring units back into the source language.

Application of Testing Process

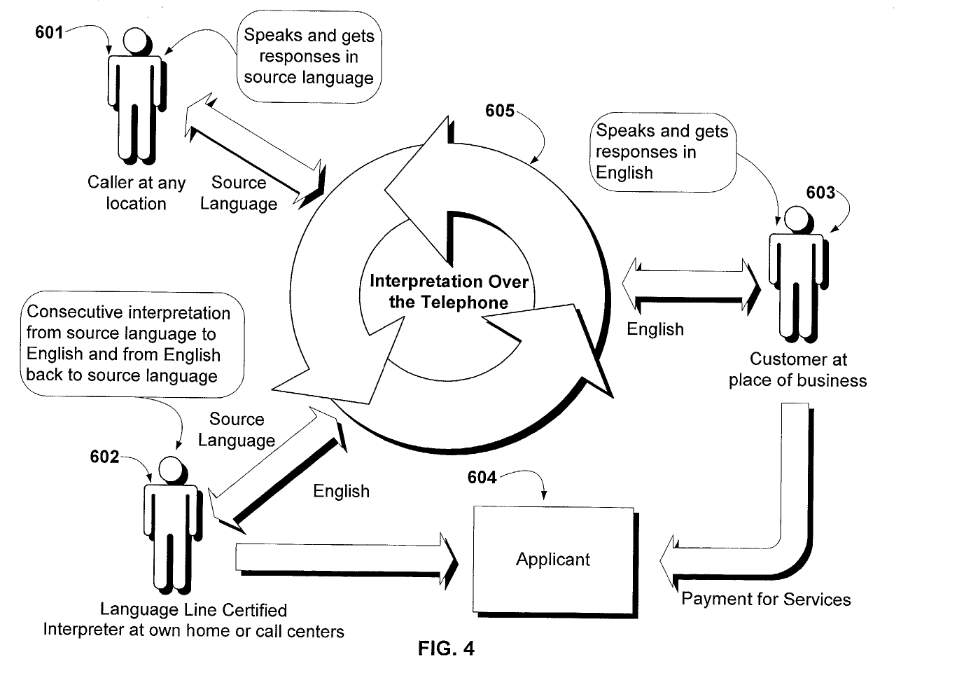

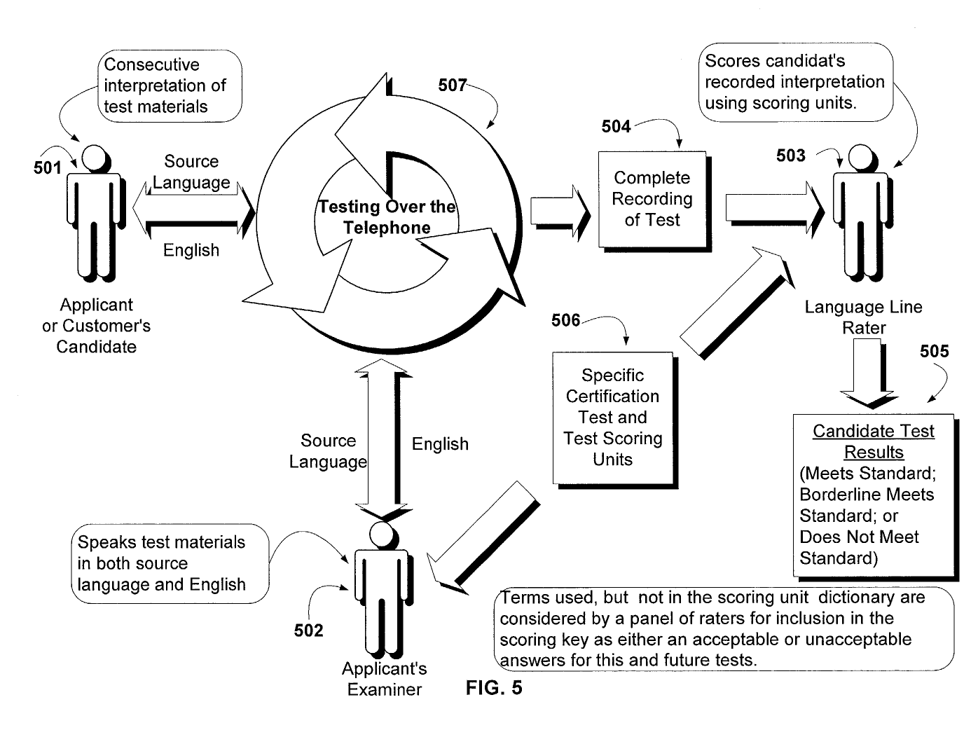

In many, if not most, instances, it is most practical, and, in fact, desired by users of interpreting services, to have direct and immediate access to certified interpreters without retaining them as full-time employees. Therefore, a significant volume of interpreting services is performed entirely over the phone in real time. Such interpreting services over the phone (1) provide interpreters offering interpreting services with a far greater market then their local geographic area is likely to provide and (2) provide consumers in need of interpreting services with direct access to certified interpreters immediately, when and as needed. As shown in FIG. 4, applicant's preferred interpreting services follow this approach. Applicant's testing process has been designed to recognize this aspect of current interpreting services and therefore, preferably, simulates this aspect of interpreting services as well. Preferably, applicant conducts the examination over the telephone to interpreters across the United States. For interpreters seeking certification, applicant's preferred implementation of phone testing is also preferred, as it permits greater access to applicant's certification system and does not entail additional expense in traveling for certification. As shown in FIG. 5, applicant's preferred testing method closely simulates its preferred method of doing business, as shown in FIG. 4, and thus supports its goal of accurately identifying qualified interpreters.

Preferably as well, the tests, as provided by applicant, may serve as an evaluation and screening tool by clients and customers of applicants who wish to evaluate potential translation employee-interpreters prior to hiring. Preferred too, the tests, as provided by applicant, may serve as an evaluation and educational tool for existing bilingual employees of clients, volunteer interpreters of clients and customers of applicant. In either of these settings, it may be preferred to administer the tests in either an oral or written form in a setting permitting greater observation of the interpreter undergoing testing.

Development of the Certification Tests

Although the specific objectives of each industry-specific test vary, the main goals of each test administered under applicant's system are as follows:

1) To identify individuals who have sufficient knowledge of industry-specific terminology and protocols to provide quality consecutive interpretation for specific scenarios, and

2) To certify their competence through a testing program.

As used herein, consecutive interpretation is understood to imply real-time, live interpretation from a source language to a target language, and vice versa.

As noted, applicant's preferred system enables certification of interpreter skills within industry-specific settings. To achieve this capability, applicant's system preferably relies on the development of tests which closely mimic the typical industry-specific settings in which the interpreter is likely to be called upon. To develop these typical industry-specific tests, applicant prefers to examine the most typical scenarios, preferably by conducting surveys with interpreters having experience taking calls from an industry, and interviews with clients and entities engaged in industry-specific business practices. Then, from the information garnered from such surveys and interviews, applicant may measurably determine and arrange the most frequent linguistic components. [For example, interviews were conducted with court clients who provided a listing of the types of scenarios that interpreters would most commonly be found interpreting in a courtroom setting.]

Applicant's system of test development incorporates the involvement of senior interpreters and language specialists with education and expertise in the industry-specific field for which the test is to be developed. Preferably, the language specialists also possess experience and skills in interpreter training, glossary development, and test design. As noted by Dr. Paul Hanges, a psychometrician from the University of Maryland, who has reviewed exam tests developed by applicant under applicant's preferred system, the involvement of test designers who actually perform interpreting duties as part of their normal employment is crucial to developing accurate test media, as well as review, feedback, and validation of the test by experts in the fields of interpreting and design.

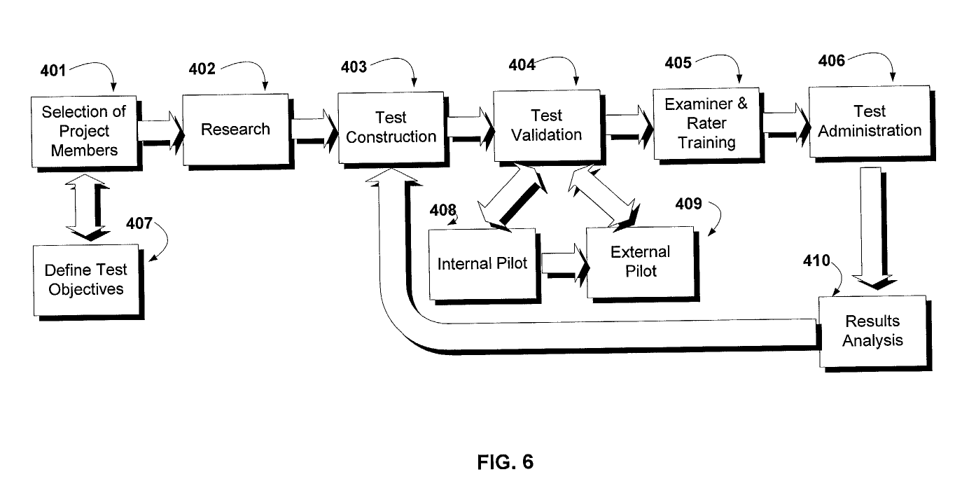

As the tests serve as a key component in applicant's certification process, due care and structure is afforded to their development. FIG. 6 demonstrates a preferred method and sequence utilized by applicant for development of an industry-specific test, preferably beginning with the step of Selection of Project Members 401 (those who will actually develop the test), then Define the Test Objectives 407 based upon the industry-specific needs, then Research 402, then Test Construction 403, then Test Validation 404 (which includes an Internal Pilot 408 of the test media and an External Pilot 409 of the test media), then Examiner and Rater Training 405, and, then, ultimately, Test Administration 406 and Results Analysis 410.

Selection of Project Members 401. In a preferred embodiment of the present invention, applicant selects project team members who have qualifications and skills pertinent to the certification test being prepared for the language pair and industry. Preferably consideration is given to active interpreters who hold Federal and State certifications, active interpreters with post-graduate degrees in translation and interpretation and current and former raters of other recognized exams such as the consortium exam for court interpretation. Additionally, others considered and preferably included are internationally recognized interpretation consultants and professors of interpretation interpreters and testers with experience designing and administering state certification tests, test designers and administrators with formal training and experience in over-the-phone testing and evaluation, and experts in the industry field. This arrangement embodies herein appointing a team for overseeing development of such interpretation test, wherein such team comprises at least one appointed participant; wherein such at least one appointed participant has recognized expertise in a particular language pair in a particular industry-specific setting; and wherein such appointing is based at least on education and experience.

Define the Test Objectives 407. In a preferred embodiment of the present invention, once the team members are selected, they are asked to prepare the test objectives considering the general objective: to identify individuals who have sufficient knowledge of industry-specific terminology and protocols to provide quality consecutive interpretation for specific industries and to certify an individual's competence through a testing program. For example, with the healthcare industry, the specific objective is for the medical certification exam to evaluate an interpreter's ability to interpret selected medical terminology in his or her working language pair, within the context of statements made in either language.

Research 402. In a preferred embodiment of the present invention, research includes several tasks such as analysis and comparison of similar interpretation tests and identification of the different strategies they employed. Additionally, numerous articles, books, and miscellaneous publications regarding test development and interpretation testing are preferably reviewed. Preferably, interpreter surveys are developed which focus on at least the scenarios most commonly interpreted, scenario content, the types of specific industry terminology most commonly encountered, categorization of the level of difficulty of the interactions, the percentage of time spent interpreting in each direction, and the length of the calls. The results of these surveys are tabulated and analyzed and used to ensure tests reflect reality of calls. Finally, feedback from focus groups with industry and language pair experience is preferably used to further validate the particular needs of the particular industry and language pair.

Test Construction 403. In a preferred embodiment of the present invention, tests are constructed using the information gathered in the research and considering all of the test theory cornerstones of sound assessment elaborated upon by Sawyer (Sawyer, David Burton. “Towards Meaningful, Appropriate, and Useful Assessment: How the False Dichotomy Between Theory and Practice Undermines Interpreter Education.”ATA Chronicle. February 2000: 32-40). Test designers also preferably tackle logistical issues such as computer software availability, the weighing of bi-directionality for certain language pairs, and the lack of linguistic equivalents among certain languages. Preferably for each industry and language pair combination multiple versions of the test are created which are equivalent in their measurement of interpreter skills. (This arrangement embodies herein preparing at least one additional version of such interpretation test in at least one language pair to assist preventing pre-knowledge of such interpretation test content by at least one such interpreter; administering such at least one additional version of such interpretation test to interpreters of equivalent skill; noting differences between such additional versions by comparing results of such administrations; and revising such at least one additional version of such interpretation test to achieve essentially comparable measurement of competency.) Development of each test includes the test, scoring keys for the scoring units, dictionaries, tester guidelines, test documentation and study materials.

Test Validation 404. In a preferred embodiment of the present invention, each new test is subjected to validation to accomplish three goals: 1) ensure test validity and reliability; 2) test refinement; 3) ensure consistency among test versions, test administrators and test raters. Each test is validated by completing one or more internal pilots, followed by one or more external pilots, followed by validation and feedback from one or more external experts in the fields of test design and interpreting, to ensure that the test meets the objective of effectively measuring a candidate's interpretation skills. Both the internal and external pilot validations are conducted in same manner as for a live test. At the completion of each test trial, candidates are preferably asked for their suggestions, opinions, and feedback.

Examiner and Rater Training 405. In a preferred embodiment of the present invention, test examiners and raters complete a course of training to ensure consistency of delivery and rating of interpreter responses. Preferably, the training content consists of the tester guidelines, test administration guide, and participation in mock administrations to practice delivery and exam protocols. Mock administrations of the test also preferably ensure that examiners become familiar with the use of tape recording equipment and with test materials, including score sheets and scoring dictionaries.

Test Administration 406. In a preferred embodiment of the present invention, once the examiner and rater training is complete, the test is placed in use for certification of candidates. Preferably, planned administration and scoring practices are followed.

Results Analysis 410. In a preferred embodiment of the present invention, post-exam debriefing sessions are held with exam administrators and Interpreter Operations Managers in order to evaluate and improve upon the actual testing process. Preferably, adaptations are made to provide for the special needs of specific language pairs demonstrated by feedback from test administrators, Interpreter Operations Managers and candidates who took the test. Preferably test administrators across languages provide feedback to the test design team on areas of concern consistently demonstrated by interpreters who did not meet the standard, for example, for the medical certification exam. Interpreter Operations Managers receive information on these noted trends and are encouraged to share these observed behaviors with the Senior Language Specialists assigned to their teams. Preferably, the Senior Language Specialists can, in turn, target these problem areas while conducting service observations and use feedback sessions with interpreters as an opportunity to address issues. It is important to note that the tests developed under applicant's system are not entirely static. Rather, as language naturally evolves to incorporate new and ever changing technologies, ideas, and expressions, the tests developed under applicant's system are designed to be continuously updated and refined. By design, much of this updating and refinement is intended to be provided (for example, as later discussed, in the updating of applicant's scoring dictionaries) by candidates seeking interpretation certification under applicant's system. This arrangement embodies herein a test-development method for creating at least one interpretation test to measure interpreter competency in language pairs in industry-specific settings, comprising the steps of: defining of at least one objective for such at least one interpretation test; identifying most-likely interpretation scenarios by surveying actual interpretation instances in at least one industry-specific setting in at least one language pair; identifying most-likely interpretation scenarios by interviewing at least one expert in such at least one industry-specific setting for interpretation in such at least one language pair; from such identifications of such most-likely interpretation scenarios, developing, for more uniform scoring, at least one dictionary comprising scoring units providing for essentially each proposed-test source language term a plurality of target language interpretation terms in such at least one industry-specific setting in such at least one language pair; classifying each such target language interpretation term among a desired number of scoring categories based on relative level of interpretation accuracy; constructing, for such at least one language pair, such at least one interpretation test comprising verbal scenarios containing at least a plurality of such source language terms to be interpreted into such target language; administering such at least one interpretation test to a plurality of interpreters; scoring such at least one interpretation test for each such plurality of interpreters using such dictionary comprising scoring units; and for at least each particular target language response on each such at least one interpretation test calling for a non-zero scoring unit and not listed in such dictionary comprising scoring units, determining an appropriate such scoring category to be assigned to such particular response and adding such particular response and category assignment to such dictionary comprising scoring units.

Test Development Details

In a preferred embodiment of the present invention, for each specific industry, evaluation of interview data permits applicant to identify “core” material that is found to occur in nearly every typical scenario for that industry. This “core” material preferably forms the baseline scoring units to be used in the development of multiple tests that will carry equal weighting for a specific language.

As the identification of “core” material for use as scoring units is an important part of applicant's system, a key element in this testing model is the development of interpreter surveys regarding several factors related to industry-specific linguistic interactions, be they in person or telephonic. The specific goal of the surveys is to gather information, preferably in an organized and structured format, regarding: a) scenarios most commonly interpreted; b) the linguistic content most commonly at issue; c) the relative percentage of time spent interpreting to and from a specific set of languages (for example, English to Spanish, and Spanish to English); and d) the relative length of the time required to perform the interpretation services.

All survey results are preferably tabulated and analyzed, and the information is used to develop the tests, thereby enabling them to reflect the reality of setting as reported via the survey. Furthermore, interpreter feedback is gathered through the use of survey groups.

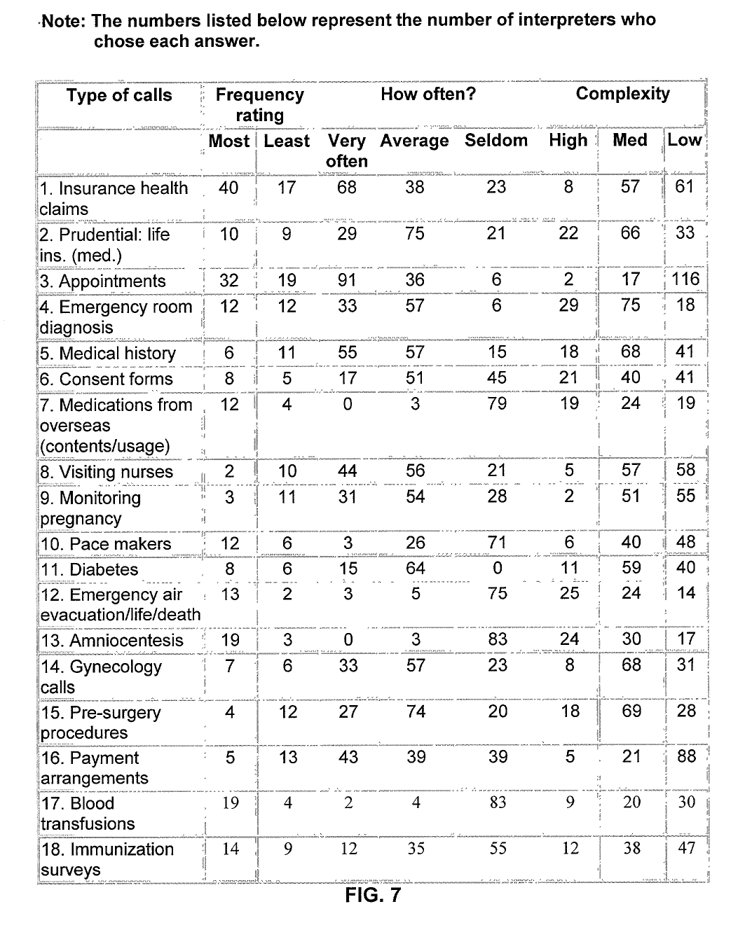

FIG. 7 illustrates a collection of the preferred type of information from interpreter feedback provided through the focus groups, used according to the present invention in assessing what the most typical scenarios are in interpreting in the selected industry (in this case, medical). As shown in FIG. 7, Emergency Room Diagnosis is consistently the most complex situation requiring interpretation, where it received a High Complexity rating of 29, and a Medium Complexity rating of 75. Similar surveys of industry personnel and focus groups are likewise used in the identification of “core” material to be used in the development of other industry-specific tests.

Noted in the Overview of the Certification Test above, there are often many ways to linguistically express an idea or statement and certainly a multitude of ways in which it may be translated. Applicant's system for certification recognizes that translation is not a binary process of either right or wrong, but that there is a sliding scale of preference depending upon and/or contingent upon many factors. A key component distinguishing applicant's system from other forms of interpretation certification is the development of individualized scoring dictionaries for each per language pair and for each industry-specific setting, including healthcare, insurance and federal, state and local courts. For each of the “core” scoring units imbedded in a given test, applicant's scoring dictionary provides a ranking of the known and acceptable translations. Words or phrases determined by applicant's system to be of the greatest precision and most formality in conveying the desired meaning and intent are of a “high” register. Words or phrases determined by applicant's system to be of successively lesser precision and lesser formality in conveying the desired meaning and intent are of a “lower” register. As used herein, “register” is a measure of the formality of utterance. Typically, a “high” register utterance would be that expected from an expert in the given field. Preferably, “high” register utterances and terms closest to source language meaning are assigned the highest point value. Preferably, the high point value is established to be a value of two (2). Preferably, a “low” or “lower” register utterance, conveying a less desired meaning and intent, or a less accurate term in a language where a more accurate term exists, is assigned correspondingly lesser point value. Preferably, these lesser point values range from below two (2) to zero (0), [preferably but not limited to the set (2, 1, 0)]. Applicant notes that, under appropriate circumstances, the preferred (2, 1, 0) point system currently utilized can be modified for added valuation increments should such greater range/increment in valuation be desirable. Currently, the court and medical certification tests offered in the interpretation services industry rely on testing that is only binary—a 1 or 0 point scoring system. Applicant's preferred non-binary, “middle-range”, point scoring methodology is innovative and unique.

To minimize deviation in scoring and improve accuracy, the scoring process is quite specific and as objective as possible. The parameters for determining how many points a given interpretation would be awarded are as follows:

a) two points—The examinee renders the scoring unit from the source language to the target language by:

i) using terminology cited in reference materials as a proper linguistic equivalent for the term, with no deviations from standard pronunciation, no grammatical errors, and with conservation of register.

ii) using a synonym cited in reference materials as a proper linguistic equivalent for the term, with no deviations from standard pronunciation, no grammatical errors, and with conservation of register.

iii) using words or phrases that accurately convey the meaning of the term, as defined in reference materials, with no deviations from standard pronunciation, no grammatical errors, and with conservation of register, when a standard and proper linguistic equivalent fails to exist in the target language.

b) one point—The examinee renders the scoring unit from the source language to the target language by:

i) using terminology cited in reference materials as a linguistic equivalent for the term, without conserving register, with no deviations from standard pronunciation and no grammatical errors.

ii) using terminology cited in reference materials as a proper linguistic equivalent for the term, with no deviations from standard pronunciation, with conservation of register, and with no more than one grammatical error.

iii) using a definition of the scoring unit's meaning cited in reference materials, with conservation of register, no deviations from standard pronunciation, and no grammatical errors, when a standard and proper linguistic equivalent exists in the target language.

iv) using terminology cited in reference materials as a proper linguistic equivalent for the term, with no more than one deviation from standard pronunciation.

c) 0 points—The examinee renders the scoring unit by:

i) omitting the scoring unit from the interpretation.

ii) using terminology cited in reference materials as a proper linguistic equivalent for the term, with two or more deviations from standard pronunciation.

iii) using terminology not cited in reference materials as the proper linguistic equivalent for the term.

iv) leaving the term in the source language.

v) using a definition of the scoring unit's meaning not cited in reference materials.

vi) using terminology cited in reference materials as a lower register linguistic equivalent for the term, with one or more deviations from standard pronunciation.

vii) using terminology cited in reference materials as a lower register linguistic equivalent for the term, with one or more grammatical errors.

viii) using a definition of the scoring unit's meaning cited in reference materials, with one or more deviations from standard pronunciation.

ix) using a definition of the scoring unit's meaning cited in reference materials, with one or more grammatical errors.

This method embodies herein setting a respective scoring value for each respective such scoring category. This method embodies herein setting a respective scoring value for each respective such scoring category comprises the steps of: setting a scoring value of two to “most accurate” level of interpretation accuracy; setting a scoring value of one to “accurate” level of interpretation accuracy; and setting a scoring value of zero to “least accurate” level of interpretation accuracy.

Such a system, as achieved by applicant, is preferred, since it incorporates the ability to recognize multiple forms of interpretation, while providing a consistent means for comparison and ranking. New interpretations provided by translation candidates undergoing testing are recorded, evaluated and added to the scoring dictionary with the relative point value deemed appropriate under applicant's system. In such instances, the score of the candidate providing the new interpretation will be adjusted to properly reflect the newly-ranked interpretation. This arrangement embodies herein a dictionary for scoring of interpretation tests for at least one language pair in at least one industry-specific setting comprising: scoring units structured and arranged to provide, for essentially each source language term of at least one such interpretation test, a plurality of target language interpretation terms in such at least one language pair in such at least one industry-specific setting; and classifications of each such target language interpretation term among a desired number of scoring categories based on determined level of interpretation accuracy. This arrangement embodies herein wherein such scoring units are determined from identifications of most-likely interpretation scenarios in such at least one language pair in such at least one industry-specific setting. This arrangement embodies herein wherein such scoring categories comprise assigned scoring values of: two to “most accurate” level of interpretation accuracy; one to “accurate” level of interpretation accuracy; and zero to “least accurate” level of interpretation accuracy.

Analysis of the survey data also permits applicant to determine the approximate length of time for which a test should be preferably conducted to most parallel the typical scenarios to be encountered in industry-specific settings. For example, with respect to applicant's survey results data collected during analysis of legal and court settings, it was determined that the greatest number of interpreters received calls that lasted from 15 to 30 minutes. Therefore, applicant determined the preferred target test administration for the industry-specific legal interpretation tests to be a maximum of 30 minutes. Further testing of simulated legal interpretation scenarios indicated that the average time for test administration was 28 minutes. Of that time, approximately 5 minutes was allocated to conveying the test instructions and answering basic questions about the testing process, preferably, by reading them to the candidate taking the test. In light of the 5 minutes allocated to test instruction, the true length of actual testing is understood to be a preferred 23 minutes. Similar analysis and test duration determination is, of course, performed for each industry-specific setting including healthcare, insurance and the courts.

One of the primary goals in designing industry-specific certification exams is to derive an exam format that realistically reflects the types of linguistic demands likely to be encountered during the course of performing interpretation duties within the given industry-specific setting. Sentence format typical of spoken dialog is, therefore, the preferred format of testing under applicant's system. By intention and design, the test sentences preferably incorporate a context for the scoring units being tested. More specifically, a interpreter working in the medical field will typically not encounter, or be required, to interpret a single specific term in isolation. Rather, the interpreter will be required to regularly interpret medical terminology within the context of statements made by the patient to the provider, and vice versa. Therefore, the tests, according to applicant's system, are preferably designed to reflect situations, topics and terms commonly encountered in an industry-specific setting (medical, legal, or otherwise). Additionally, embedding scoring units in sentences and statements is likely to elicit proper interpretations and corresponding utterance responses from the examinee for terms that have a number of correct, yet different interpretations, depending on context.

Sentence format is preferred for the testing format; as it permits the exam to cover a wide range of industry-specific subjects, as is likely to occur with, for example, a medical intake examination. Further, sentences can be rearranged and rewritten to contain the same scoring units, but in a slightly different presentation. This versatility permits applicant to create a number of tests to be created with equal weight. The use of multiple tests insures against memorization and familiarity, as are likely to occur with repeated testing.

Preferably, each test is divided into about 25 test segments, providing for interpretation from the source language (preferably English) to the target language, and preferably, 15 segments for interpretation from the initial target language back into the initial source language (preferably English). Such a preferred division further reflects the reality of typical interpretation setting modeled by the test, for example, the interactions between a patient and a care provider, wherein the care provider typically uses more medical terminology and speaks more often at greater length than the patient.

In a preferred embodiment of applicant's system, as applied to rare languages, for example, such as Tagalog, Hmong, Serbian, Croatian, Bosnian, Somali, and Farsi, applicant's system is adapted to utilize preferably 40 test segments translated from the source language (the rare language) into the target language, preferably English.

It is to be noted that applicant's system for developing certification tests must preferably be performed in the entirety for each set of source and target languages. Specific attention to issues of cultural relevance, nontraditional practices, ethnic groups, gender, religion, regional variants, and a multitude of other factors preclude simply translating a known working set of language certification tests into a new set of source and target languages. Indeed, this practice, as taught by applicant's system, preferably permits the development of customized certification tests that recognize and address the uniqueness of the languages, peoples, and cultures involved in the translation process.

Implementation of the Certification Tests

Preferably, all occurrences of testing under applicant's preferred system are recorded. Such recording thereby permits greater accuracy in scoring while providing a verifiable reference for future comparison. Preferably, this recording is audio. As noted, preferably, such administration of the certification test is conducted over the telephone using a highly scripted examiner guideline. FIG. 5 illustrates an example of a preferred way to use and embody applicant's present invention.

In a preferred embodiment of the present invention, the examiner's guidelines for administering and scoring a certification exam contains a highly scripted set of instructions to the examiner which help to insure consistency between examiners. Appendix D of Provisional Application No. 60/298,848, filed Jun. 15, 2001, entitled “INTERPRETER CERTIFICATION SYSTEM” is hereby fully incorporated herein by reference and is summarized here. The examiner's guideline for administering and scoring a certification exam preferably contains eleven steps:

Step 1: Getting Ready to Administer the Exam.

Preferably this step includes detail instructions on preparing to give the exam by reading the materials provided to the examinee, such as FAQ and Exam Candidate Information documentation. Examiners are instructed to keep all aspects of an exam confidential, before and after exams are administered. Preparation also includes becoming familiar with the test length, number of repetitions allowed and the length of a mid-exam break. Preferably, the examiner is asked to practice reading the exam and ensuring that all speed and pronunciation problems are resolved in advance. Finally, the examiner is preferably reminded to have all the required exam materials and equipment ready before the start of the exam.

Step 2: Contacting the Examinee. Preferably, examiners are instructed to place the call to the examinee and introduce themselves. Once the connection is made the interpreter is instructed to test the recording equipment, explain the testing process and not allow the examinee to ask questions until appropriate. The examiner is provided detail instructions on the handling of special situations such as the examinee's phone line is busy, there is no answer, a bad connection or refuses to take the exam. The examiner must preferably coordinate with a Manager and applicant's Interpreter Response Center to document the special situation and possibly reschedule the exam. If the examinee is confused/unsure about taking the exam the examiner is preferably instructed to state “I encourage you to go ahead and take the exam at this time. You will have other opportunities to re-take the exam if you are unsuccessful during this testing round.”

Step 3: Starting the Exam. Preferably, the examiner notes the start time of the test and must adhere precisely to the time limit set for the exam. The examiner must preferably read the exam script exactly and not be distracted by any remarks by the examinee. If examinees ask an excessive number of questions, examiners preferably need to state: “Please refer to the Candidate Information document for details regarding the exam. The exam needs to get started, so that you will have enough time to complete it.” Each exam is to be recorded completely including preliminary and final instructions, and the rest period. If the examiner encounters technical difficulties they must notify applicant's Certification Manager.

Step 4: Reading the Exam Items. Preferably examiners are required to read each statement with clarity and moderate speed stating the number of each statement pausing briefly after each statement to allow the examinee to interpret and to restate or change the interpretation. Examinees are preferably permitted a maximum of 8 repetitions during an entire exam. Examiners preferably track the number of repetitions requested on the examinee's score sheet. After the 6^{th} request for a repetition, the examiner will state: “This is your 6^{th} repetition.” After the 8^{th} request for a repetition, the examiner will state: “This is your final repetition.” Examiners will repeat an entire exam statement when an examinee requests a repetition regardless if the request is for a specific word or phrase, the spelling of a word or individual sentences in a statement. In these situations the examiner may preferably state: “Let me repeat the whole utterance.” If an examinee requests that a previous exam item be repeated, several exam items later, the examiner cannot honor the request. If an examinee asks for verification (e.g. “Did you say ‘amniocentesis’?), the examiner may preferably respond: “Yes”, if that was the word; if not the examiner can preferably state: “No, let me repeat the whole utterance.” If an examinee returns to a previous test statement to correct a term, the examiner preferably waits until the examinee is finished, and then continues exam administration. If an examinee requests permission to correct a term, state: “Go ahead.” and wait until the examinee is finished, then continue exam administration.

Step 5: Ending the exam. Preferably, when the test time has come to an end, the examiner discontinues the exam even if the examinee has not interpreted all exam items. If the examinee has started the last response at 45 minutes, they may finish that final test item. If the exam is discontinued for time, preferably the examiner will state: “The time allotted for the exam has now elapsed.” After the test is completed or discontinued the examiner preferably reads the final instructions, stops the tape recorder and notes the end time. If an exam takes the entire allotted time, examiners can advise examinees to call the IRC and request a special break if they feel they need one. The examiner will verify with the examinee that the recording is good; if the recording is bad the examiner will preferably notify the examinee that they will be notified of the need for a retest. Preferably examiners may not comment on an examinee's performance. If asked the examiner must preferably state: “I apologize, but I cannot comment on your performance.”

Step 6: Securing the Tape. Preferably, the examiner is to verify that the examination was recorded properly, if the recording is not good the examiner must notify the IRC or Certification Manager.

Step 7: Scoring the Exam. Preferably, an examiner may partially score answers during the administration of the exam using the score sheet that corresponds to the exam version if the examiner is very familiar with the contents of the exam, as well as the scoring dictionaries. Even then: the examiner needs to listen to the tape after administering the exam, to fill in the gaps that remain, and to make sure the appropriate point value was assigned according to the scoring dictionaries. At time it maybe necessary to listen to a particular response a few times to make sure there are no deviations in pronunciation. Under no circumstances should examiners create long pauses during exam administration for scoring purposes. Frequently, examiners will need to listen to the entire recording more than once, especially the first few times the examiner administers the exam. Examiners preferably will use scoring dictionaries that have been prepared by the exam designers for their language pair. Examiners preferably will score exams by looking up an examinee's responses in the scoring dictionary, as listed next to each scoring unit and mark the examinees' score sheet accordingly. When the examiner encounters variations, which are terms or phrases that are not in the scoring dictionaries, the point value is left blank and the variations is submitted to the panel via e-mail, and the variation can be researched in order to make a point value decision. The term or phrase is then added to the scoring dictionaries, and sent to all examiners on a periodic basis, so that the examiners can finish scoring the exams. Preferably examiners complete the scoring on the score sheet in pencil. Fill out all the information requested at the top of the score sheet. They will need to wait until you have finished scoring the exam to fill in the “Result” section (met standard, not met standard, re-score, incomplete, exam cancelled, exam rescheduled). Preferably, specific instructions for completing the scoring include:

Note start and end times for the exam in the space provided on the score sheet while administering the exam.

Use the start and end times to calculate the duration of the exam after administering the exam before detailed scoring.

Keep track of repetitions requested by the examinee while administering the exam marking an “X” over the corresponding number each time the examinee requests a repetition. Inform the examinee about their 6^{th} repetition, as well as their final repetition. (Refer to “Step 4: Reading the Exam Items”.)

Track examinee's responses by using the score sheet columns, which appear next to the individual scoring units.

If the examinee gives a 2-point response (according to the scoring dictionary), check the corresponding box in the 2-point column.

If the examinee gives a 1-point response (according to the scoring dictionary), check the corresponding box in the 1-point column.

If the examinee omits or skips the scoring unit, check the box in the 0-point column, and write a circle with a diagonal line through it in the “Response” column on the far right-hand side of the score sheet.

Fill out the “Response” column on the far right-hand side of the score sheet. Filling in this column is optional for 2-point responses, but all 1-point and 0-point responses rendered by the examinee must be listed in the “Response” column. This space is used whenever there is a question about a response provided by an examinee. Note of examinee responses for individual scoring units, in cases where a variation to scoring unit is provided that is not found in the scoring dictionary. These responses will be submitted via email so that point values may be assigned and so that the responses may be added to the scoring dictionaries.

Tally the results at the end of the score sheet. Procedures for calculating final results are addressed in “Step 8: Tallying the Results”.

For a term or phrase that is not in the scoring dictionaries, leave the point value blank for that term temporarily and submit a list of these variations t on a daily basis via e-mail. The terms will be researched in order to make a point value decision. The Project Leader will add the variations to the scoring dictionaries, and send updated versions of the dictionaries to all examiners on a periodic basis, so that the examiners can finish scoring their exams prior to score submission deadlines.

Variations need not be submitted for mispronunciations of scoring units, grammatical errors in scoring units, grammatical equivalents of scoring units, lengthy responses, containing the scoring unit words, word order within the scoring unit and completely incorrect answers of scoring units.

Mispronunciations of scoring units and grammatical errors in scoring units are awarded one point. Grammatical equivalents of scoring units, lengthy responses, containing the scoring unit words, and word order variations within the scoring unit are awarded full credit, while completely incorrect answers of scoring units receive no points. Deviations and errors in non-scoring unit parts of statements do not affect the examinee's score.

To avoid deducting points when an examinee has interpreted correctly, it is best to submit the response as a variation, unless the answer is completely and obviously incorrect. Examiners should preferably submit responses known to be correct and it is not in the scoring dictionary.

The Exam Results Report form is preferably filled out for every examinee and will be sent out to examinees by applicant. In addition to the final objective score, examiners identify any performance areas that presented a particular problem in the rendition by the examinee, as well as those that were well executed. What follows is a brief description of each category:

Omissions: Did the examinee leave out any words that were marked as scoring units?

Left Scoring Units In-Language: Did the examinee leave any of the scoring units in the source language during his/her rendition?

Embellishment: Did the examinee add and/or expand on the message being conveyed into the target language? Were the additions minor, or major?

Changes in Meaning: Did the examinee misinterpret the message content, and alter the meaning of what was being conveyed into the target language? Were the changes minor, or major?

Delivery or Rendition Unclear: Did the examinee render the interpretation in such an awkward and jumbled manner, as to confuse the message being conveyed?

Slow Response Time: Did the examinee keep pace with the examiner, or did he/she disrupt the rhythm of the dialogue with very slow response time?

Paraphrasing/Summarizing: Did the examinee consistently paraphrase or in any way summarize any part of the interpretation? Did the examinee restrict the units of meaning in the rendition, or omit or add units of meaning, explanatory phrases, interjections, and/or other words that did not originate from the source language utterance?

Fluid and Clear Delivery: Did the examinee consistently interpret smoothly, without pauses or hesitations that did not originate from the source language?

Faithful Rendition: Did the examinee offer a rendition that was true and complete in every relevant and necessary way, leaving the intended message intact?

Voice volume: Was the examinee's voice and pitch of a volume and tone that were neither too soft nor too loud to be easily understood?

Call Protocols: Did the examinee consistently adhere to applicant's call protocols, such as interpreting in the first person where required, and referring to him/herself in the third person when clarifying/requesting repetitions?

Exams will preferably conclude at 45 minutes, regardless of how many exam statements remain. The examiner preferably discontinues exam administration, assigns a point value of “0” to the remaining exam items that were not administered, scores the exam, and submits the result to applicant's office.

If a correction is provided in the same test statement, it is considered; if it is provided in a later test statement, it is not considered.

If an interpreter gives multiple responses for a particular test item, only the last response is to be considered and scored.

If an examinee starts the exam, but is unable or unwilling to complete it, the examiner ends the exam after the examinee states he/she does not wish to continue, and calculates the score based on the responses provided. If the score indicates that the examinee has met the standard for the exam, label the Score Sheet accordingly. If the score indicates that the examinee did not meet the standard for the exam, label the Score Sheet accordingly. If the score indicates the need for a re-score, examiners follow standard re-score procedures listed below in the section “Step 8: Tallying the Results”.

If an exam can not be administered because of a busy signal or no answer, label the Score Sheet and Data Tracking Sheet as “Test Cancelled.”

If an exam can not be administered because of a bad connection, label the Score Sheet and Data Tracking Sheet as “Test Rescheduled”.

Step 8: Tallying the Results. After point values are assigned to all responses on the Score Sheet, add up the total number of points, or the raw score. Refer to the raw score values at the bottom of the Score Sheet to determine if the candidate has met the standard, not met the standard, or needs a re-score. After calculating the raw score, calculate the percentage score by: 1) Divide the examinee's raw score by the total possible number of points for the exam version; 2) Multiply the result by 100; 3) If the result is a whole number, this is the percentage score; and 4) If the result is a decimal number, round it off to the nearest whole number. Write the percentage score on the front of the Score Sheet in the space provided. Also, note this percentage score on the Data Tracking Sheet. (This embodies herein scoring such interpretation test for each such plurality of interpreters using such dictionary comprising scoring units, comprises the steps of: summing a total of such scoring values for each such interpreter for each administration of such interpretation test; and assigning such total as an objective score.) Exams that receive a score between 65 and 69 are preferably sent to a different examiner for a re-score. The results of the second scoring of the exam will be considered final and the appropriate notification will be sent to the examinee. This is done to ensure scoring consistency among examiners for “borderline” examinees.

Step 9: Using the Data Tracking Sheet. For each examinee's Data Tracking Sheet fill in “version”, “duration”, “score” and “result” sections, after administering and scoring their exams. Use the percentage score in the “Score” column. Use the following options when filling out the “result”? column: 1) met standard; 2) not met standard; 3) re-score (Re-score is used for only by languages where more than one examiner is available; languages with only one examiner will not use this option); 4) exam cancelled; 5) exam rescheduled; or 6) incomplete. If an examinee did not take the exam because it had to be cancelled or rescheduled, write “N/A” in the “score” column, and “exam cancelled” or “exam rescheduled” in the “Result” column.

Step 10: Submitting Materials. Verify there is a tape and score sheet for every interpreter that was examined. Prepare the materials and ship via overnight delivery service to applicant's Certification department.

Step 11: The Debriefing Session. All examiners are invited to participate in a post-exam debriefing session, to improve the examination process by sharing ideas and suggestions for improvement.

These steps embody herein administration of at least one such interpretation test by strict adherence to a fixed test administration protocol for at least one such interpretation test.

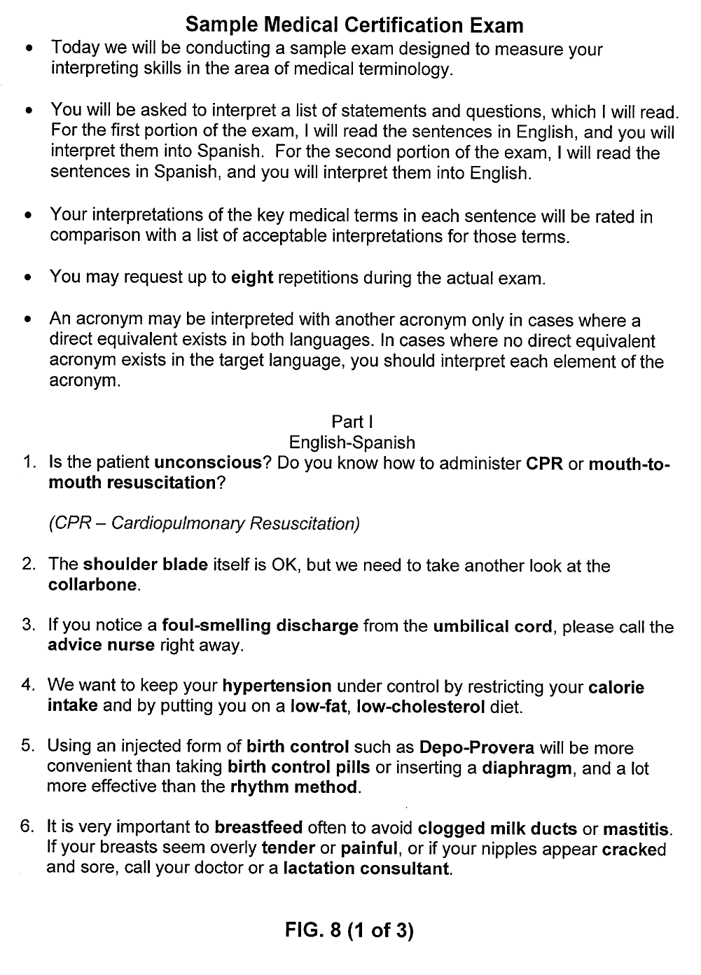

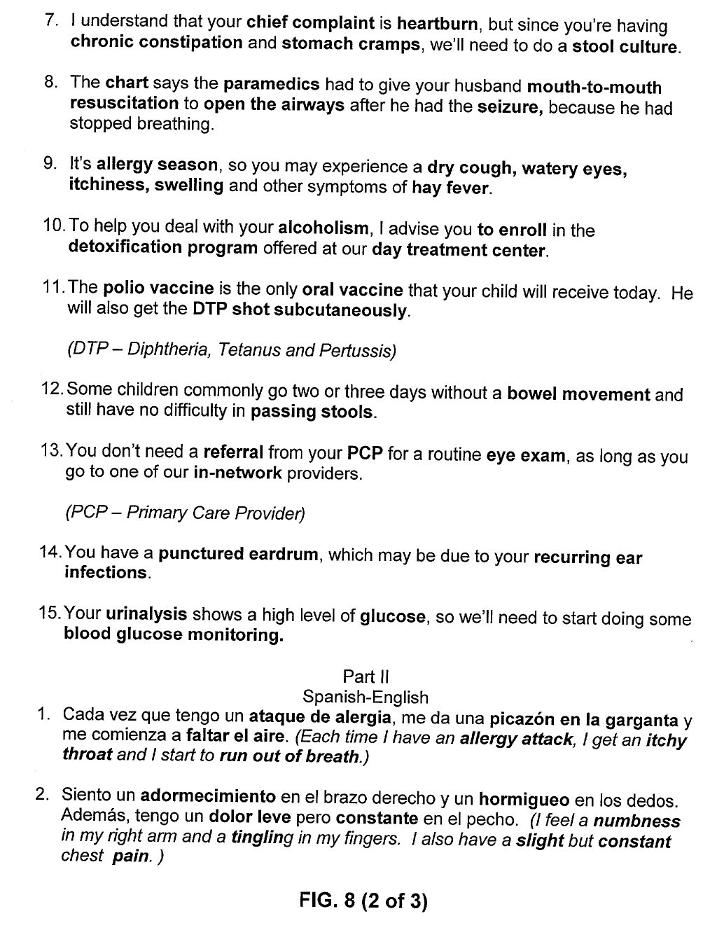

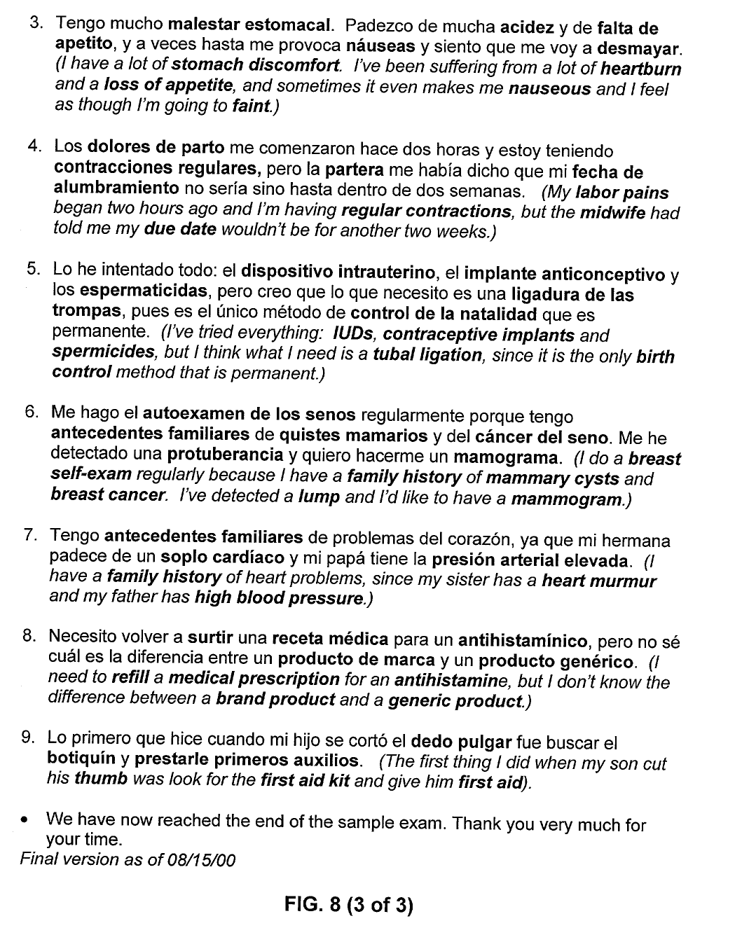

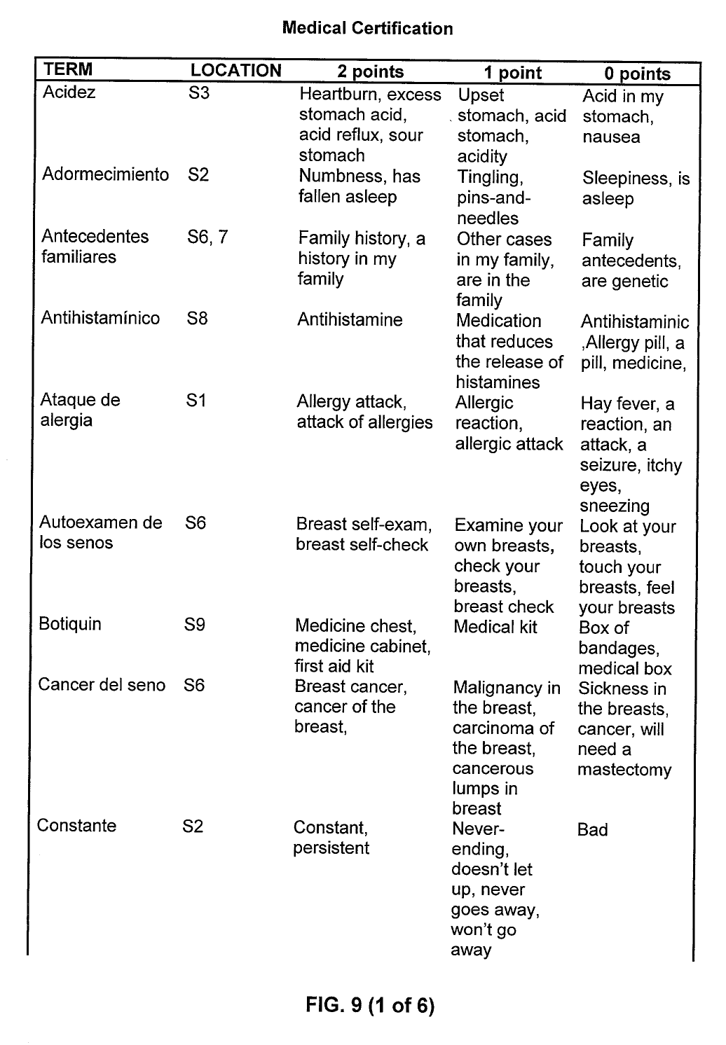

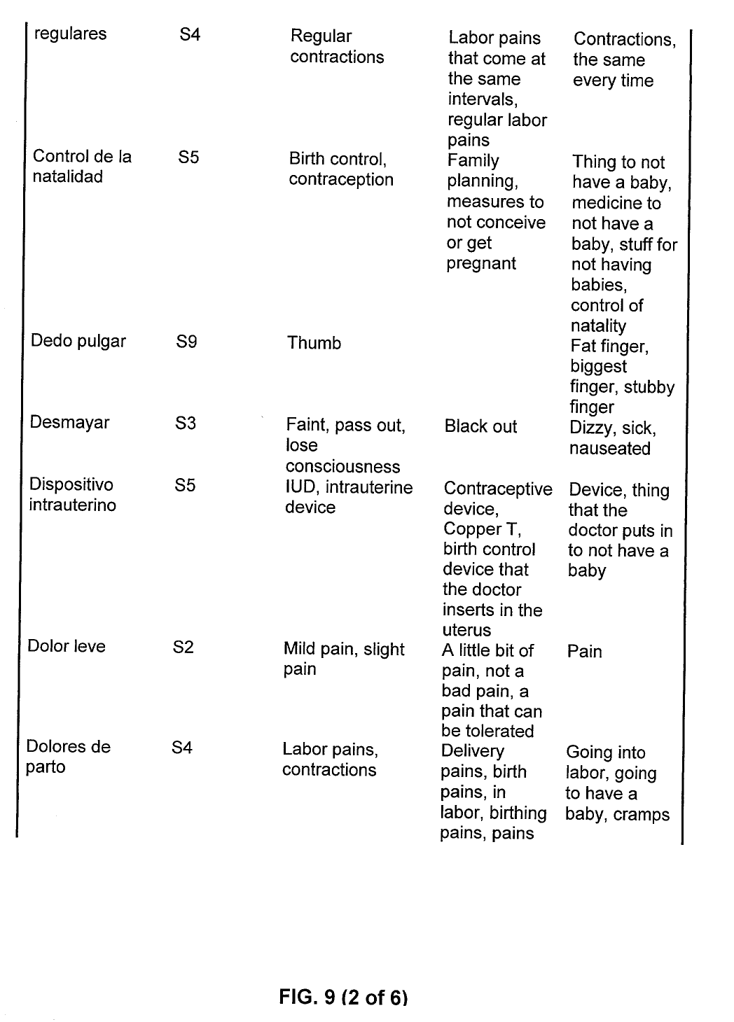

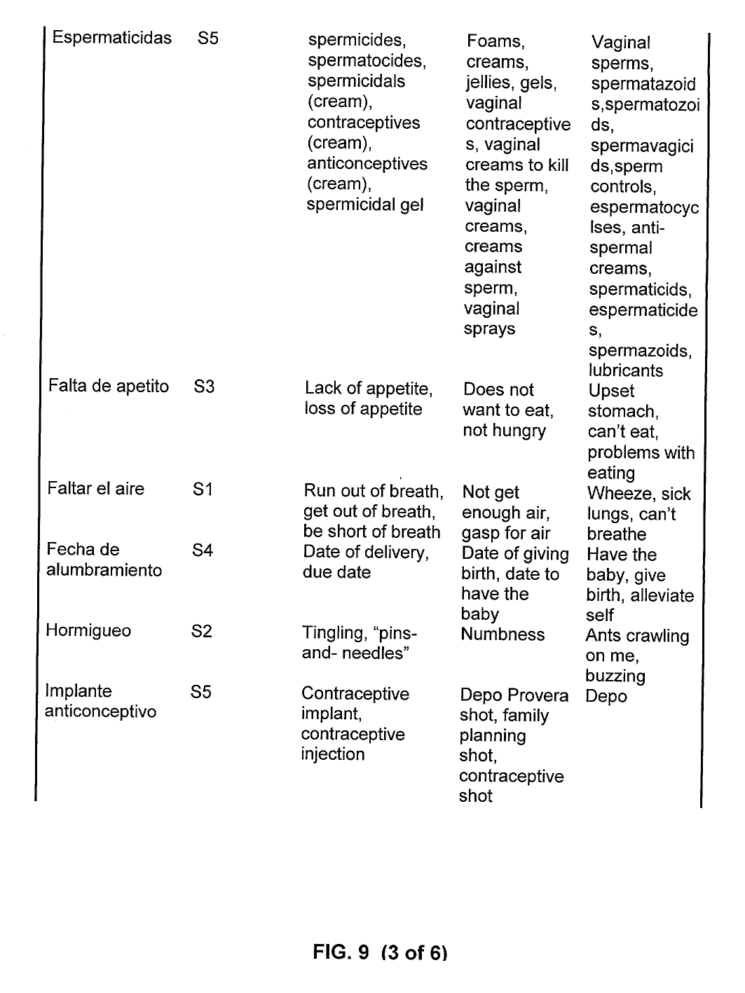

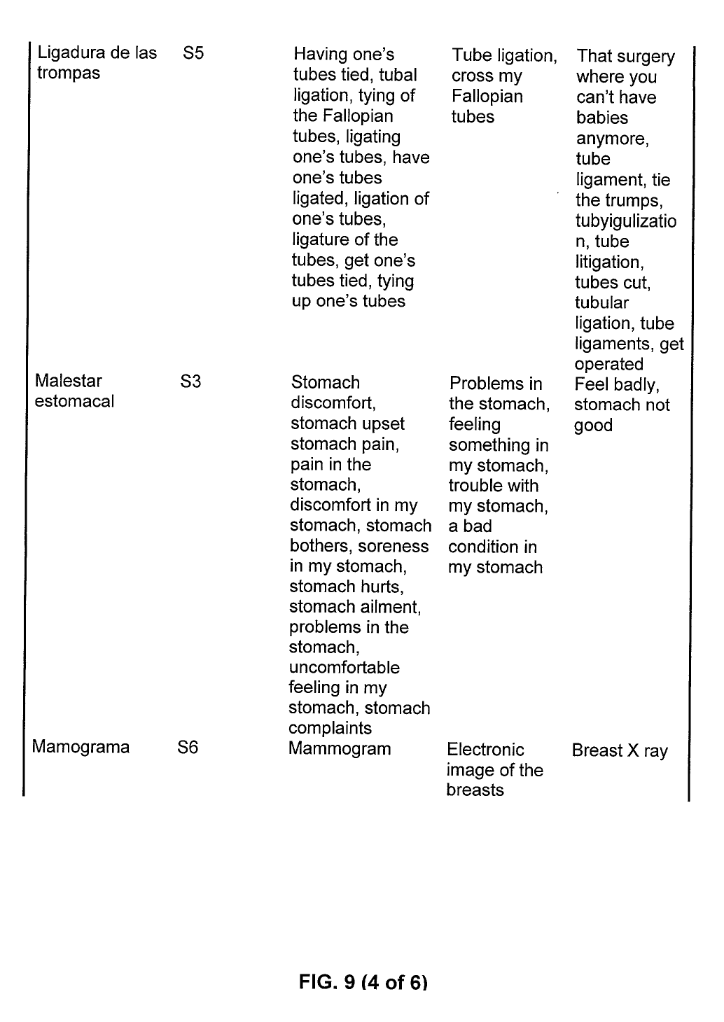

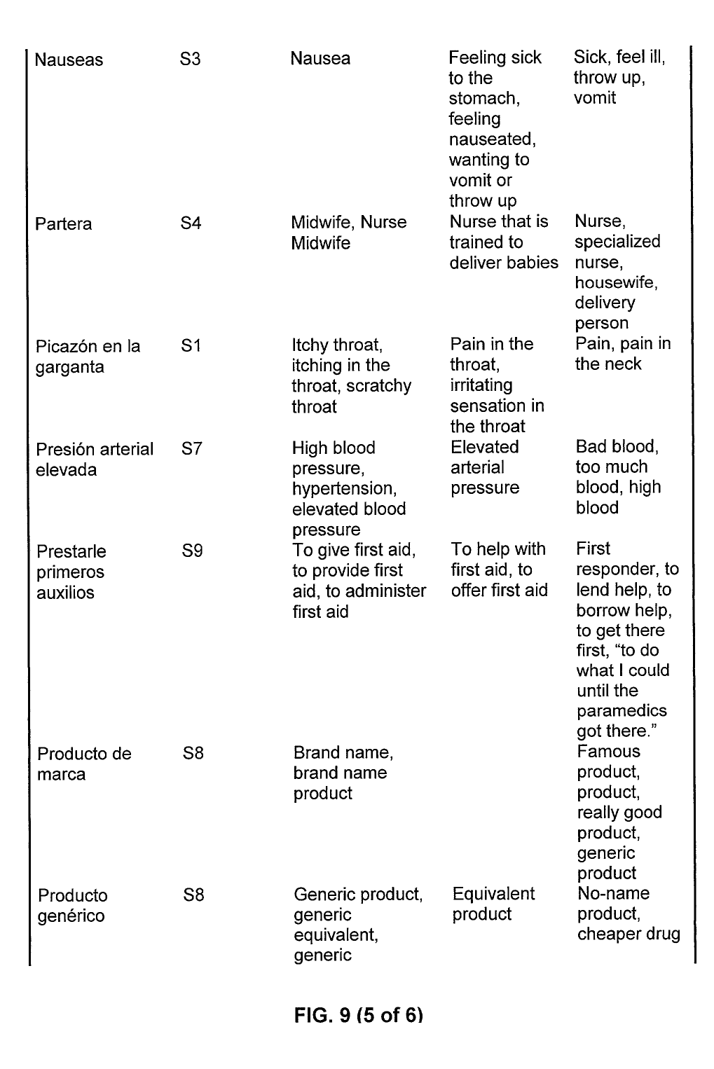

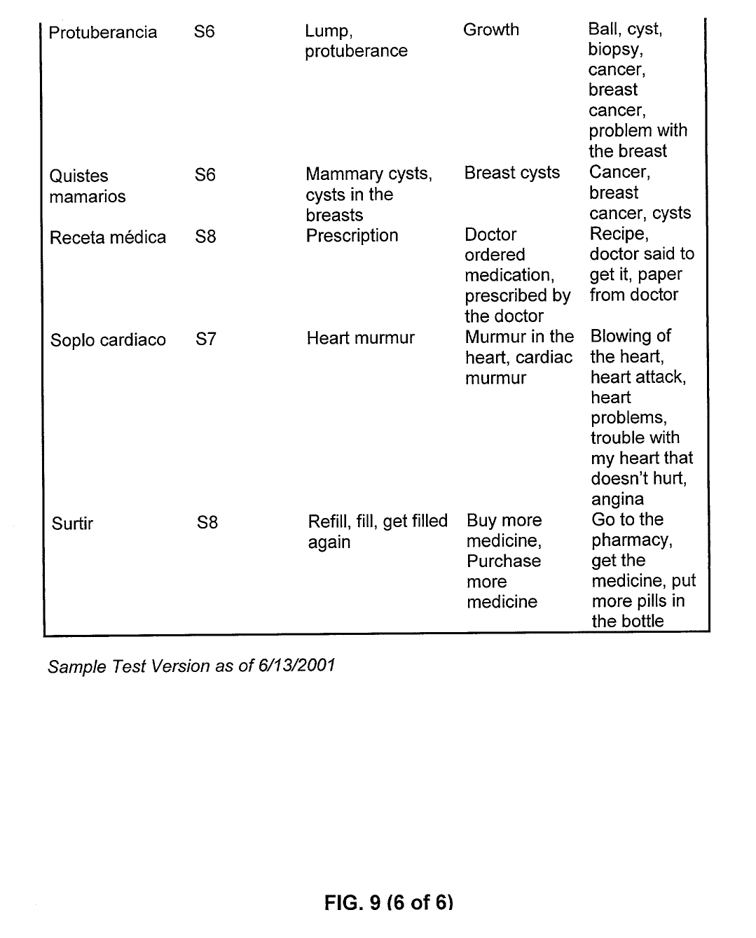

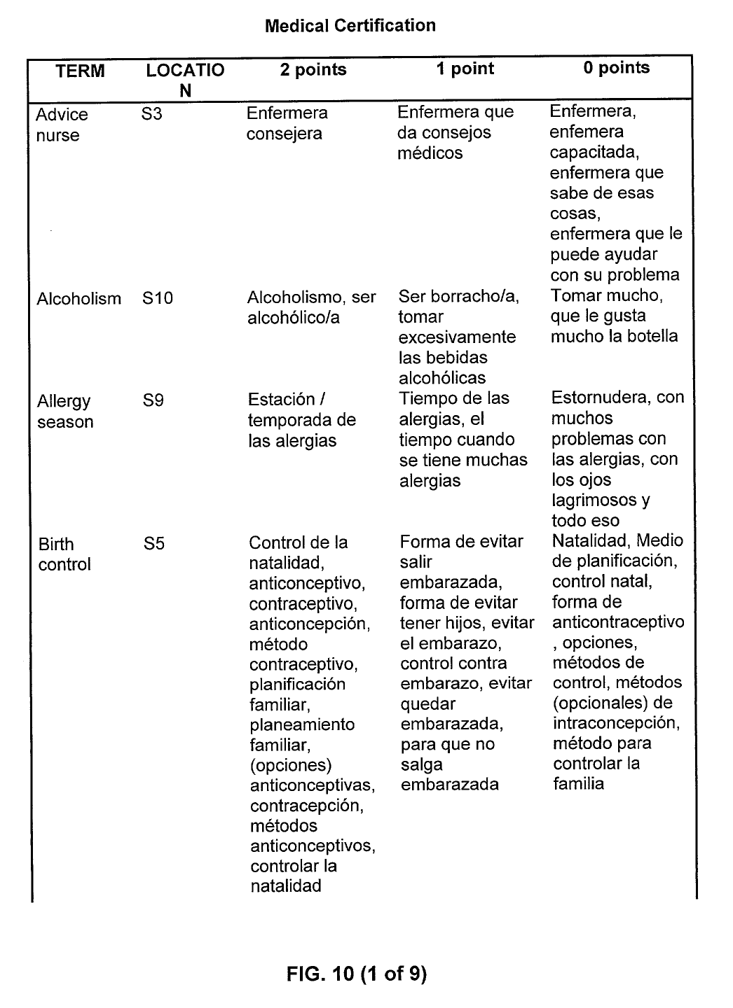

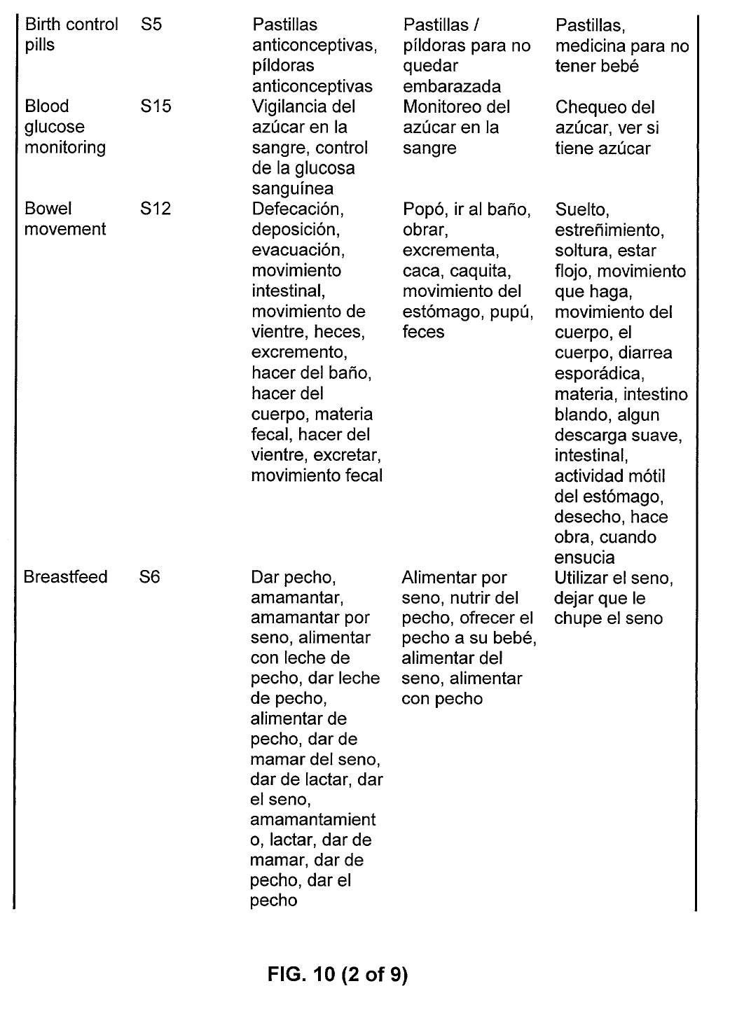

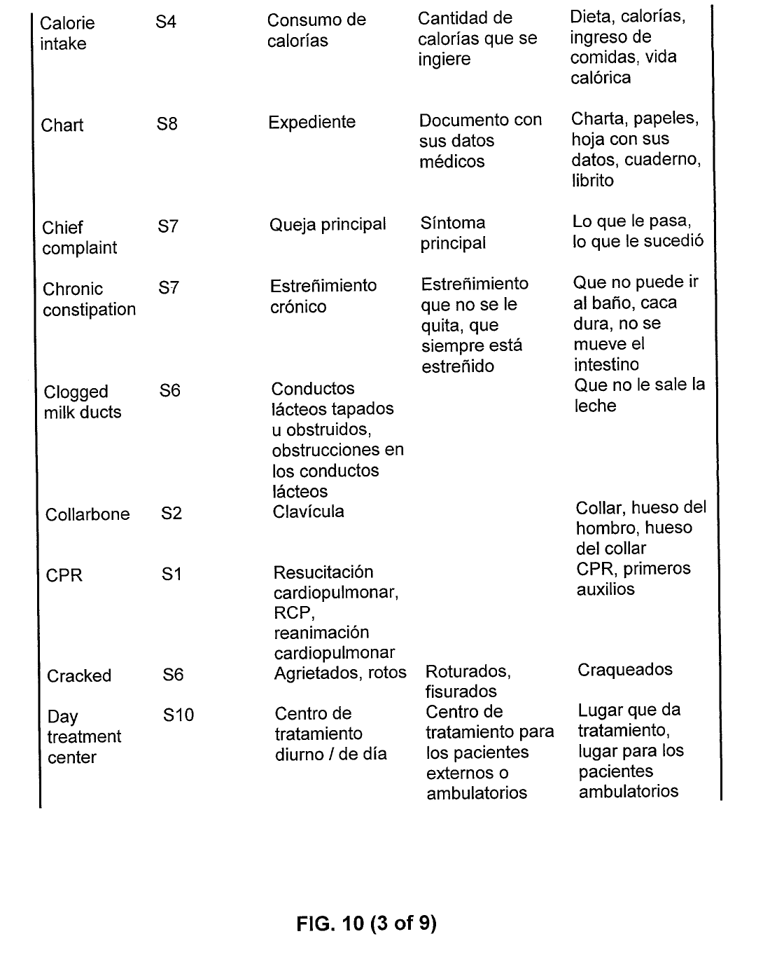

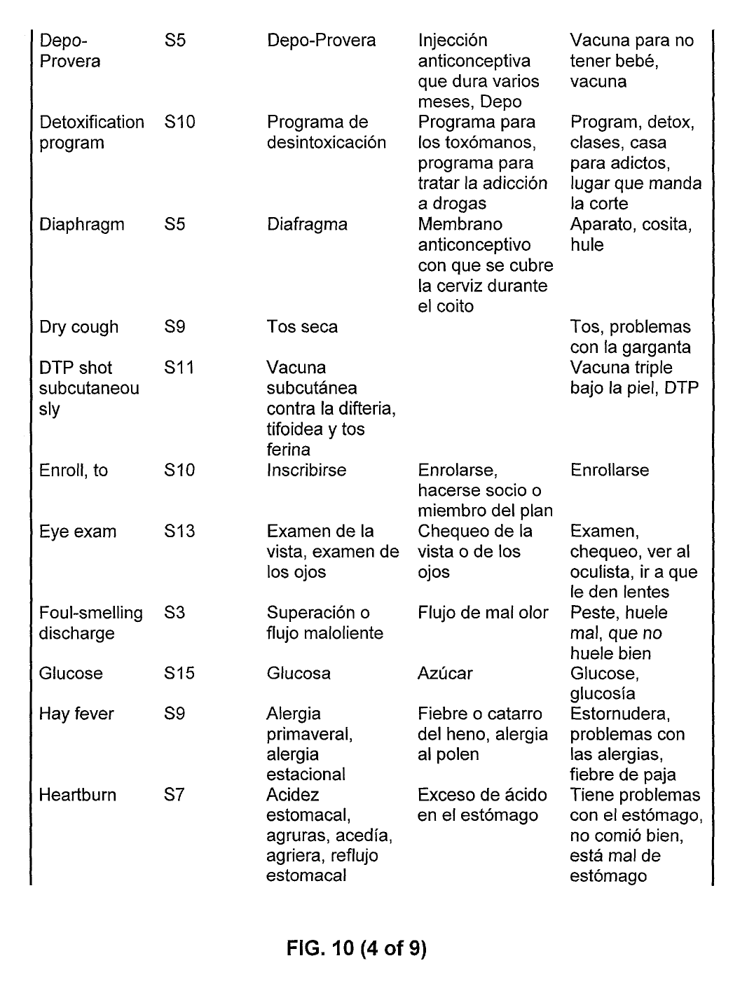

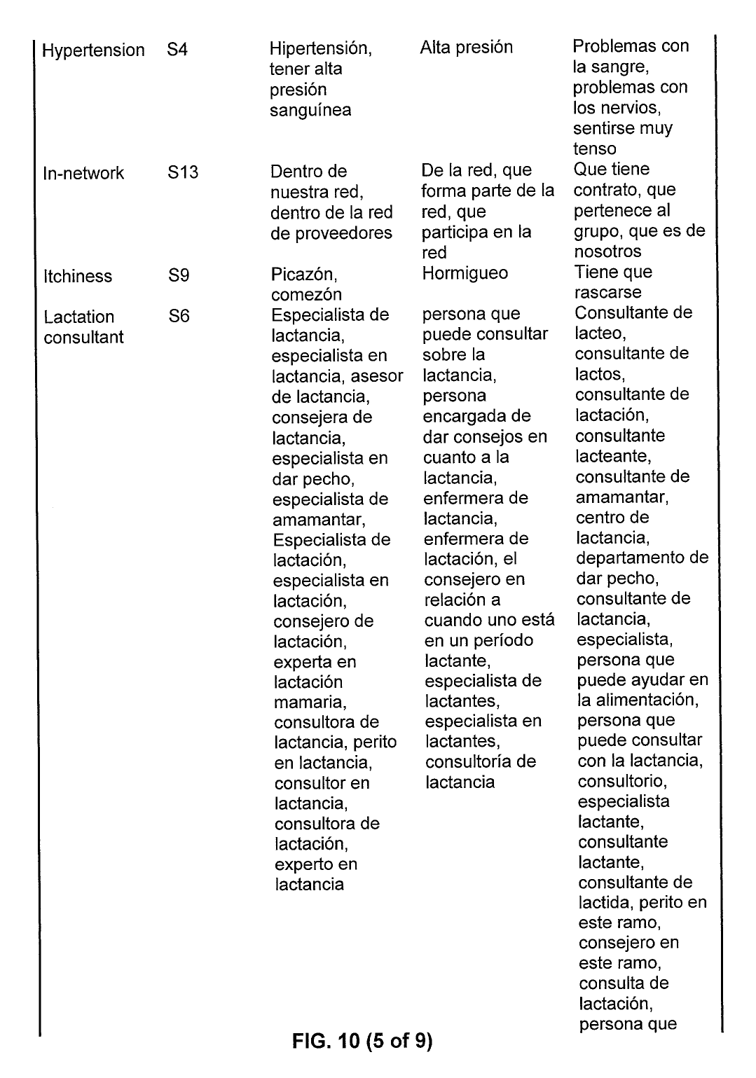

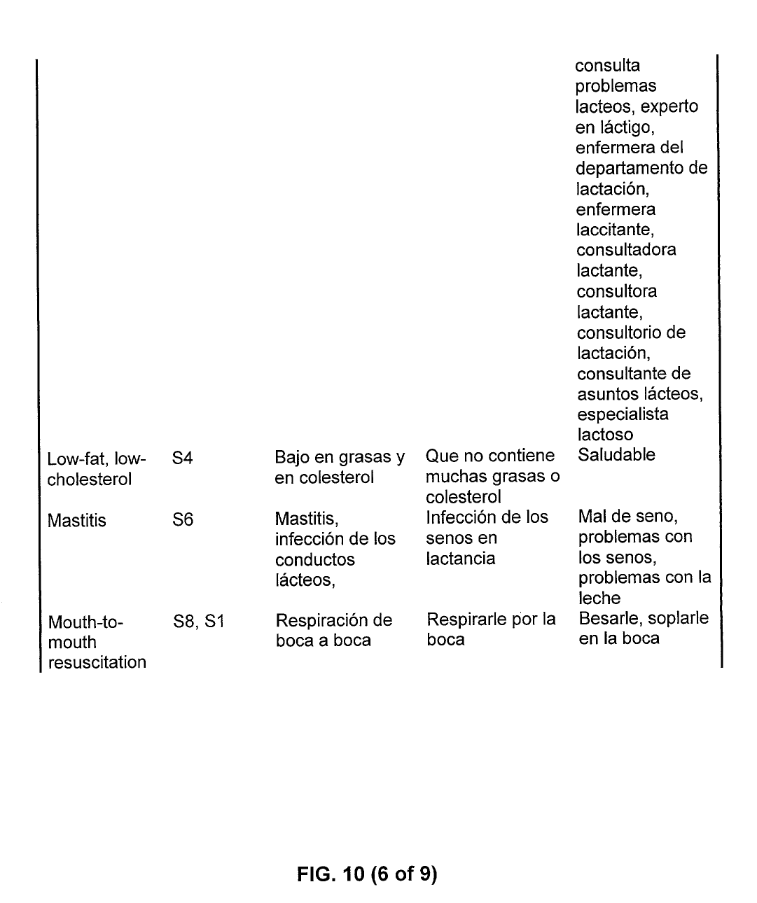

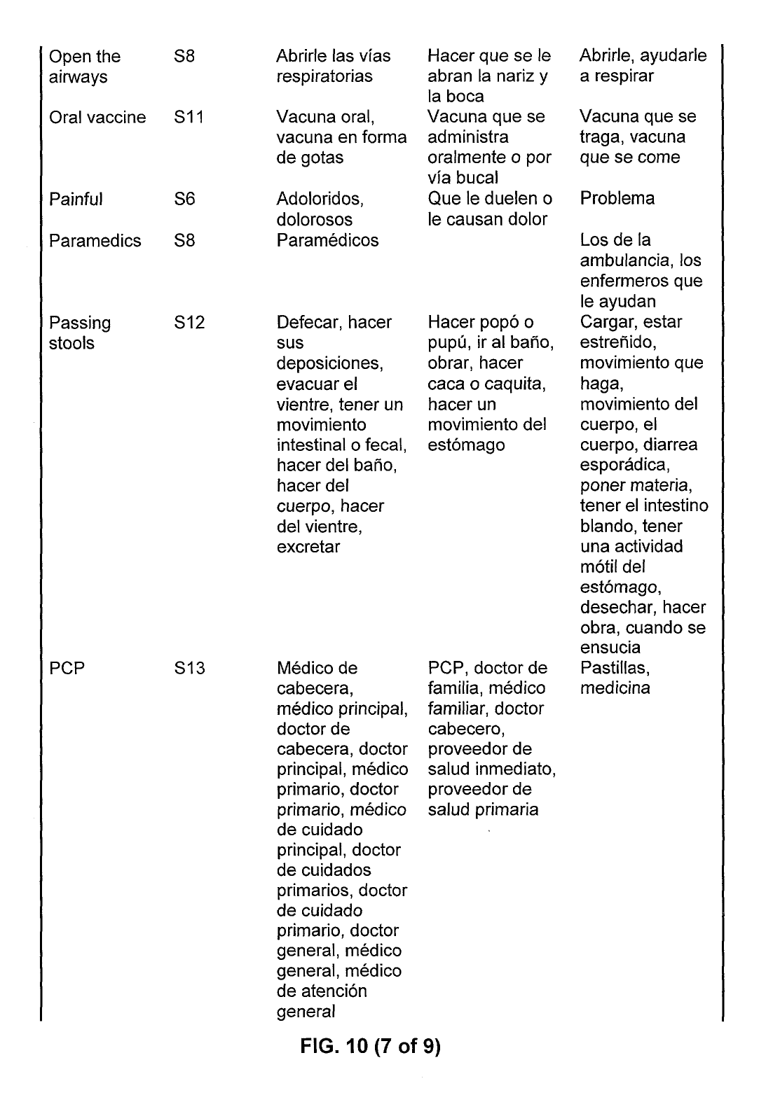

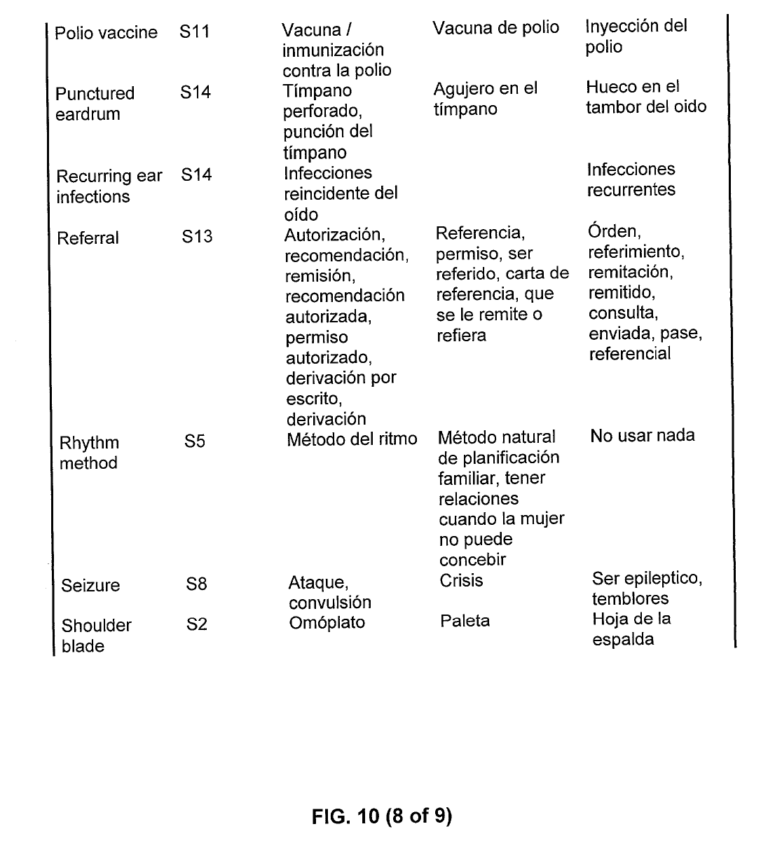

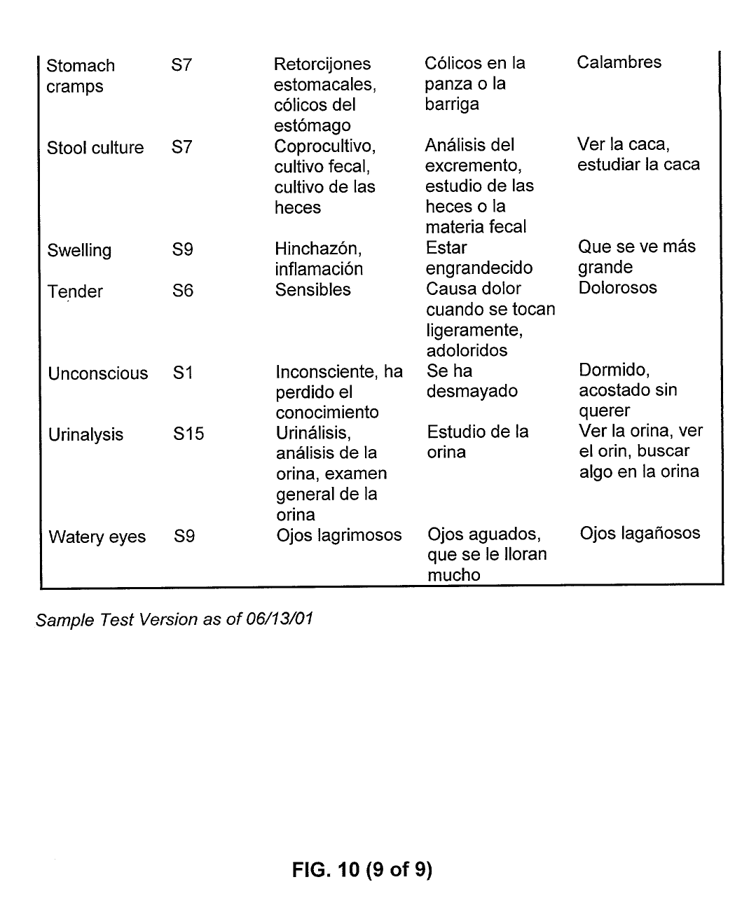

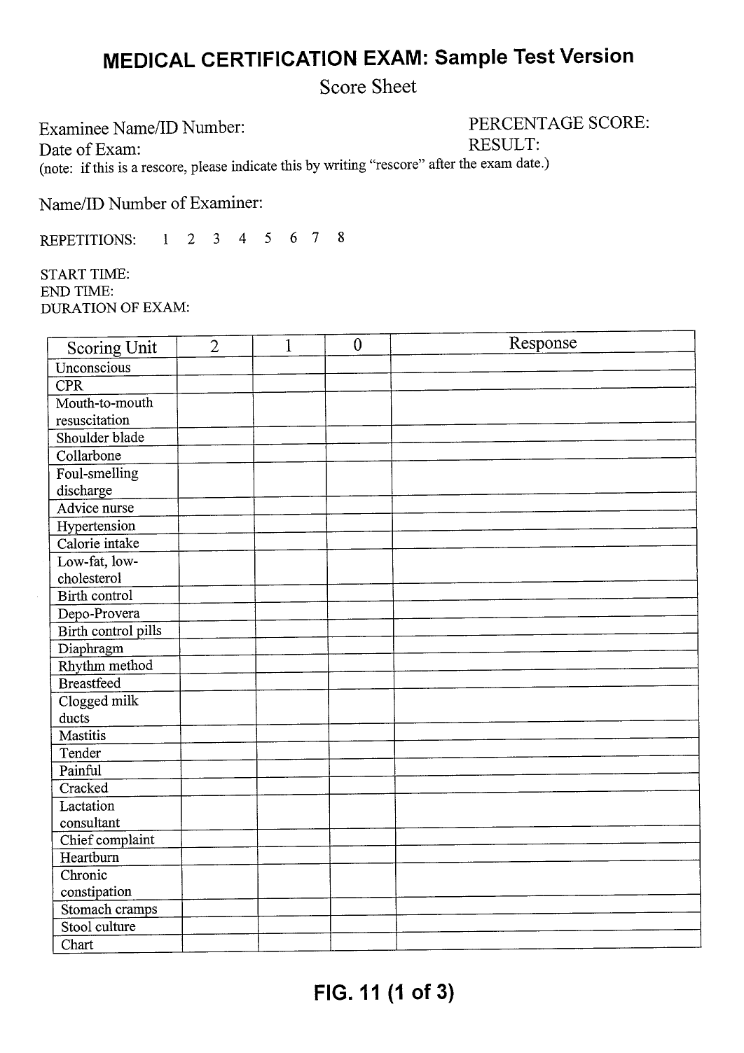

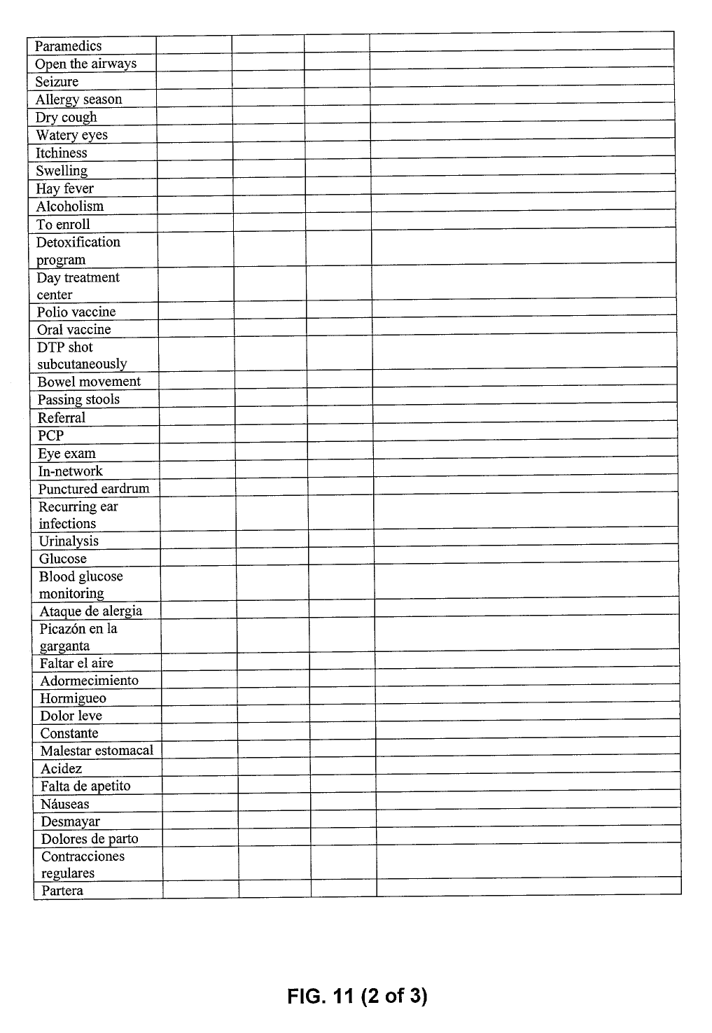

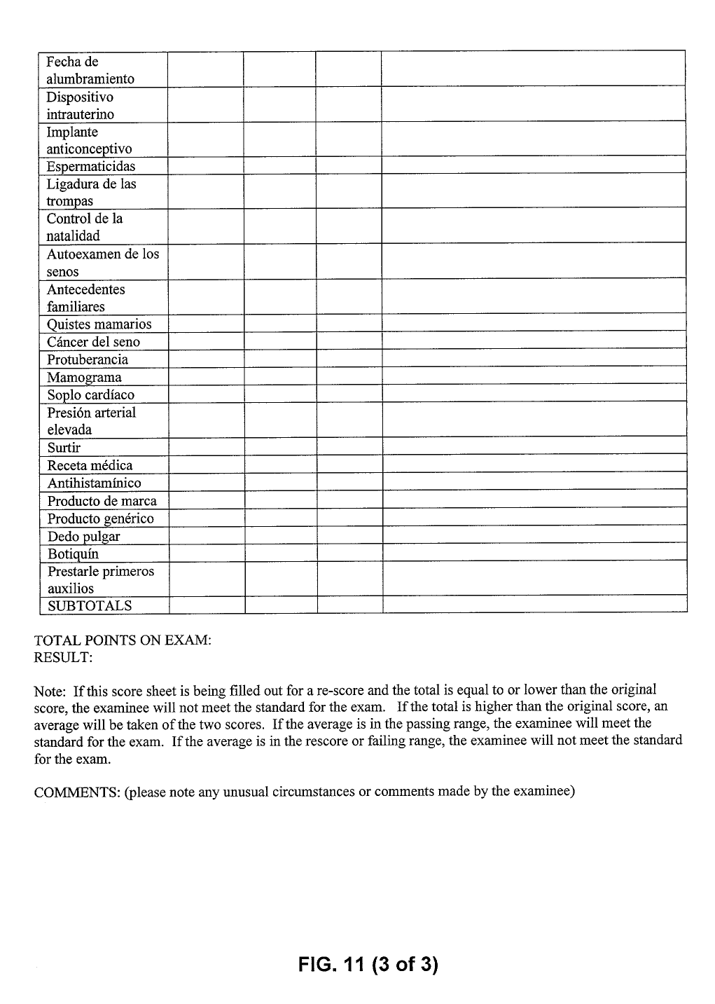

Specific examples of preferred materials used in applicant's invention are described with respect to FIG. 8, FIG. 9, FIG. 10, and FIG. 11. It is noted that the examples provided in these figures are intended as abbreviated sample materials.

FIG. 8 illustrates a sample specific certification test 506, testing proficiency for interpretation in the medical industry in a manner preferred. In this preferred embodiment, and for this particular sample test, the test is preferably administered orally. It is noted that the test instructions are embedded so as to be uniform. It is also noted that the test encompasses 2-way interpretation skills, i.e., English to Spanish in Part I, and Spanish to English in Part II. Due to the two-way translation testing encapsulated, it is preferred that the test administrator/rater be fluent with both the source and target language.

The scoring units present in the examination are marked, preferably as shown in bold, so as to be easy for the test administrator to identify. As the preferred administration of the test involves recording of the test session, the test administrator may, or may not, perform the functions of test rater, as well. Preferably, the test administrator will also act as test rater. As will be discussed shortly, it is preferable to have at least two persons review and score an interpreter candidate's test and performance. For purposes of this application, applicant reiterates that the sample material provided is a representative example only, as a full test intended to occupy 23 minutes of discussion would serve no purpose not achieved by the sample material.

FIG. 9 illustrates a sample Spanish-to-English scoring dictionary of the type preferably available to each test administrator/rater to assist in the scoring process. As illustrated, the listings of FIG. 9 tie together the many principles that have been discussed with regard to applicant's present invention embodied in the interpretation certification system. Each scoring unit term from the source language appears with its identified location within the test. As noted, interpretation utterances in the target language are ordered by register and accuracy and assigned scoring point values relative to their “high” or “low” register and most or least accurate valuation. The preferred utterance interpretations are preferably assigned a point value of 2. Partially acceptable utterance interpretations are preferably assigned a point value of 1, as they are acceptable in interpreting the gist of the meaning or intent of the source, but they are not of the “high” register or most accurate utterance value that would be expected by an expert in a given field. Translations that are meaningful, but which fail to convey the meaning or true intent of the source, are assigned a point value of 0. Obviously unacceptable interpretations will be recognized by the scorer without the assistance of the dictionary and are awarded a point value of 0.

Similar in form and content, FIG. 10 illustrates a sample English-to-Spanish scoring dictionary of the type preferably available to each test presenter/scorer to assist in the scoring process. Each scoring unit term from the source language appears with its identified location within the test. As noted, translation utterances in the target language are ordered by register and assigned scoring point values relative to their “high” or “low” register valuation. The preferred utterance interpretations (as noted, where appropriate, there are preferably a number of words and phrases that qualify as preferred “high” register utterances) are preferably assigned a point value of 2. Partially acceptable utterance interpretations are preferably assigned a point value of 1, as they are acceptable in translating the gist of the meaning or intent of the source, but they are not of the “high” register utterance value that would be expected by an expert in a given field, nor do they carry the most exact meaning. Interpretations which are meaningful, but which fail to convey the meaning or true intent of the source are assigned a point value of 0. Obviously unacceptable interpretations will be recognized by the rater without the assistance of the dictionary and are awarded a point value of 0.

FIG. 11 illustrates a sample scoring sheet preferably used by the examiner for the sample test of FIG. 8. Each scoring unit embedded in the test is listed in a simple-to-use table format, permitting the indication of awarded point value and notation of the uttered interpretation response.

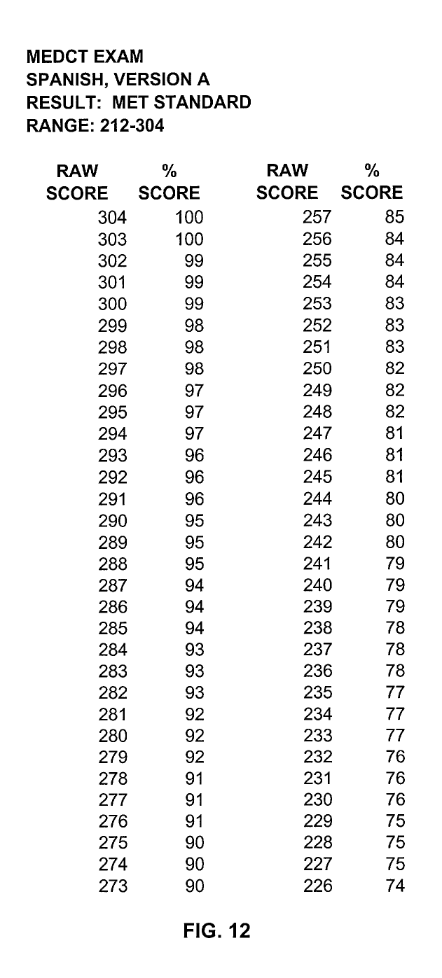

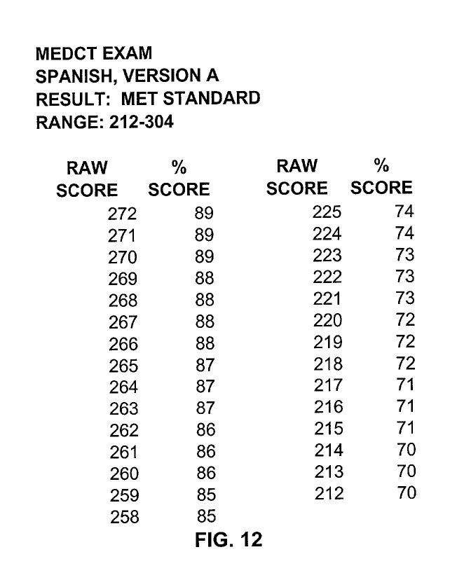

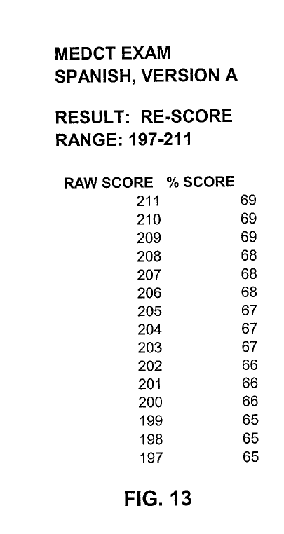

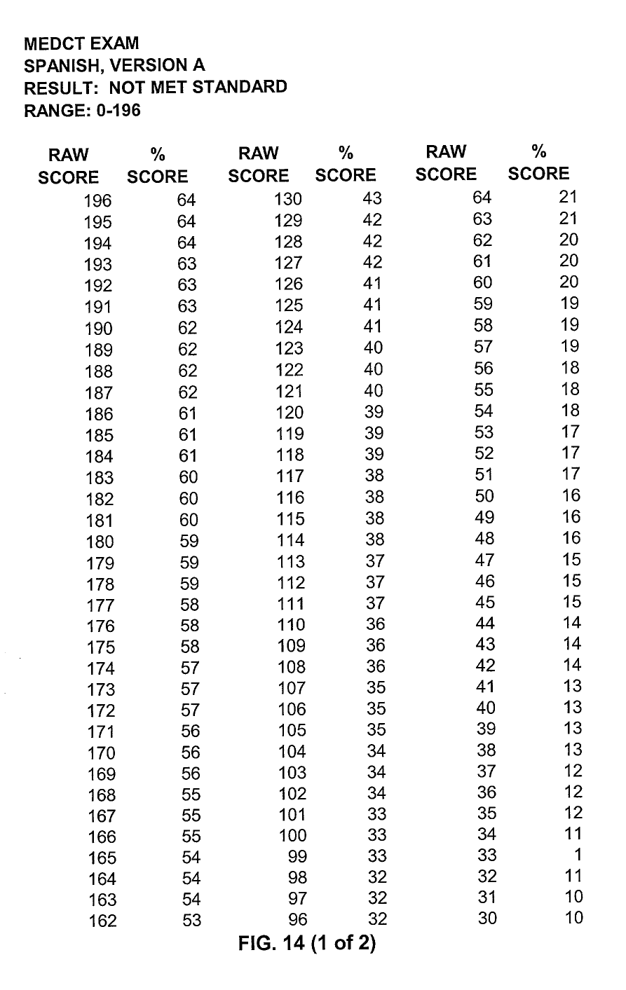

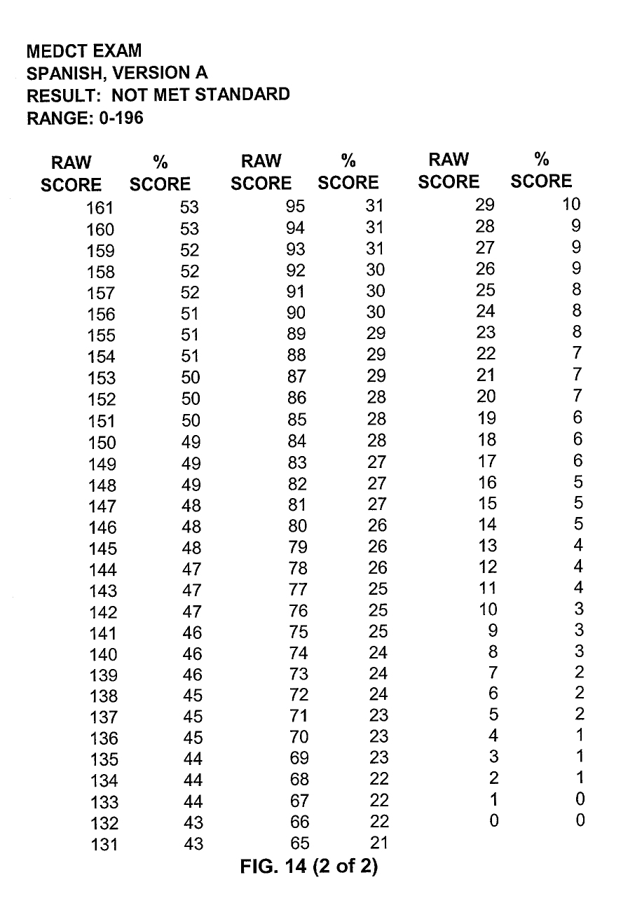

A tally of awarded points is performed to acquire the certification candidate's raw score. This raw score is then preferably translated to a percentage score by means of a conversion chart, such as exampled in FIG. 12. (This arrangement embodies herein scoring such interpretation test for each such plurality of interpreters using such dictionary comprising scoring units, comprises the steps of: summing a total of such scoring values for each such interpreter for each administration of such interpretation test; and assigning such total as an objective score.) Moreover, FIG. 12 illustrates a table comparing and associating the examinee's raw score, preferably computed by simple mathematical tally of the awarded points associated to scoring unit, with that of a percentage score. To achieve certification for industry-specific interpretation under applicant's system, a certification candidate must achieve a grade percentage of at least 70%. Borderline cases are preferably recognized to be between 65% and 70%, with grade percentages below 65% preferably being deemed insufficient for certification. A percentage score in the borderline range is preferably re-scored by a different rater, and as such, verified for accuracy. Preferably, should a higher percentage score result from the re-scoring, the examinee is awarded the higher score.

In the event that an examinee provides an interpretation that is not currently listed in the scoring dictionary, but which is also not obviously incorrect, the interpretation is preferably noted and brought to the attention of an evaluation panel. Preferably, the panel researches the response, assigns a point value, enters the response into the corresponding scoring dictionary, and alerts test administrators and raters to the new point values and responses incorporated into the dictionaries. This process also ensures inter-rater reliability, since all responses are scored according to the same point values, and all responses are recorded so that current and future examinations can be scored in consistently the same fashion.

Other Customer Services

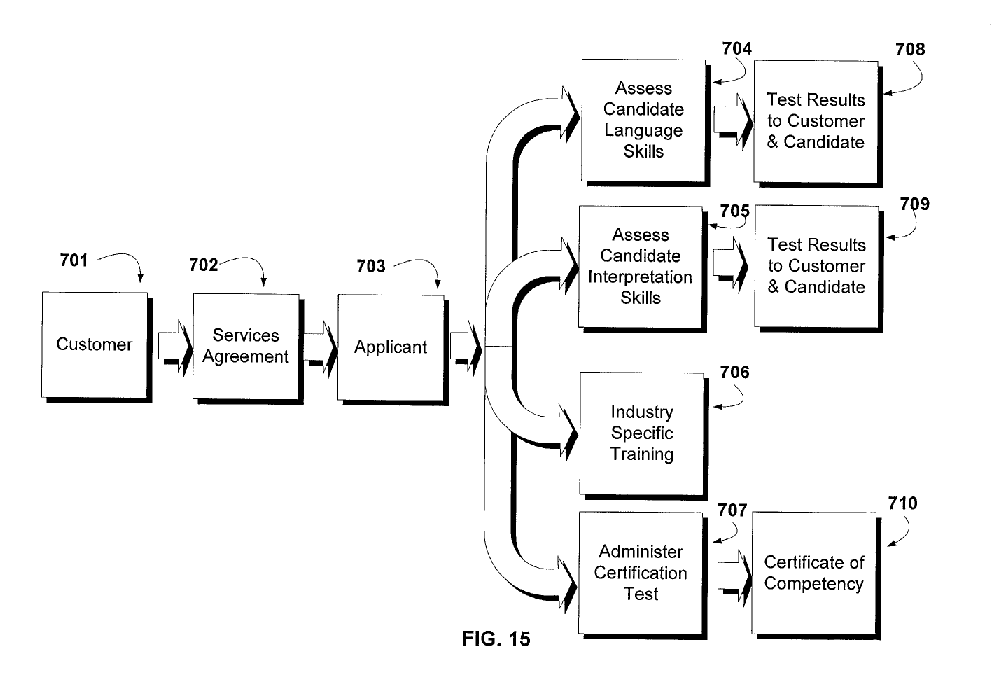

In a preferred embodiment of applicant's system, applicant has developed methods for providing training and testing for a customer's employee-interpreters. As illustrated in FIG. 15, applicant provides a variety of testing and training services to customers in addition to interpretation services. As shown, customer 701 and applicant 703 will complete an agreement 702 for one or more services. These services may preferably include assessment of customer's employee-interpreter's language proficiency skills in a particular language pair 704, assessment of customer's employee-interpreter's oral-consecutive interpretation abilities in a particular language pair 705, training in terminology specific to the customer's industry 706, and certification testing 707 of the customer's employee-interpreters in the use of the industry-specific terminology in the employee-interpreter's language pair. The results of the assessments and certification testing are reported to both the employer and the employee-interpreter 708, 709 and 710.

Implementation of Employee-Interpreter Certification Tests

Preferably, information about the testing product is mailed to clients who may register through a mail-in, e-mail or by telephone. The client then preferably receives a Monday-through-Friday testing schedule for enrolling its employee-interpreters for an individual test date and time. Preferably, the enrollment is returned at least two weeks before the proposed testing dates. Applicant preferably confirms the scheduled test date and time via email with the client and makes the arrangements with the test examiners in the requested languages to be available to administer the test.

Preferably at the test date and time, the examiner calls in to the applicant's Interpreter Response Center, which then connects the examiner with the employee-interpreter at a pre-established contact telephone number. The test is preferably administered one-on-one over the phone, in consecutive mode, with the entire testing process requiring about two hours. The test itself preferably takes 45-60 minutes, depending on the language, with the remainder of the time being allotted to rating and completing a scorecard that will be sent to the client for each interpreter tested.

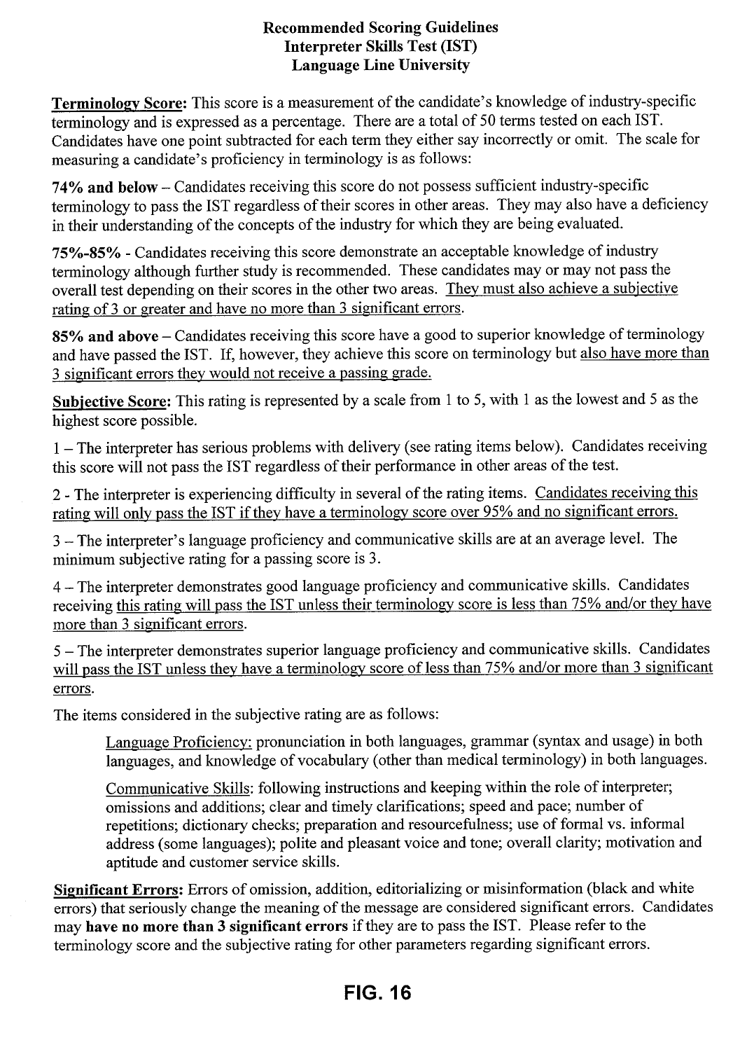

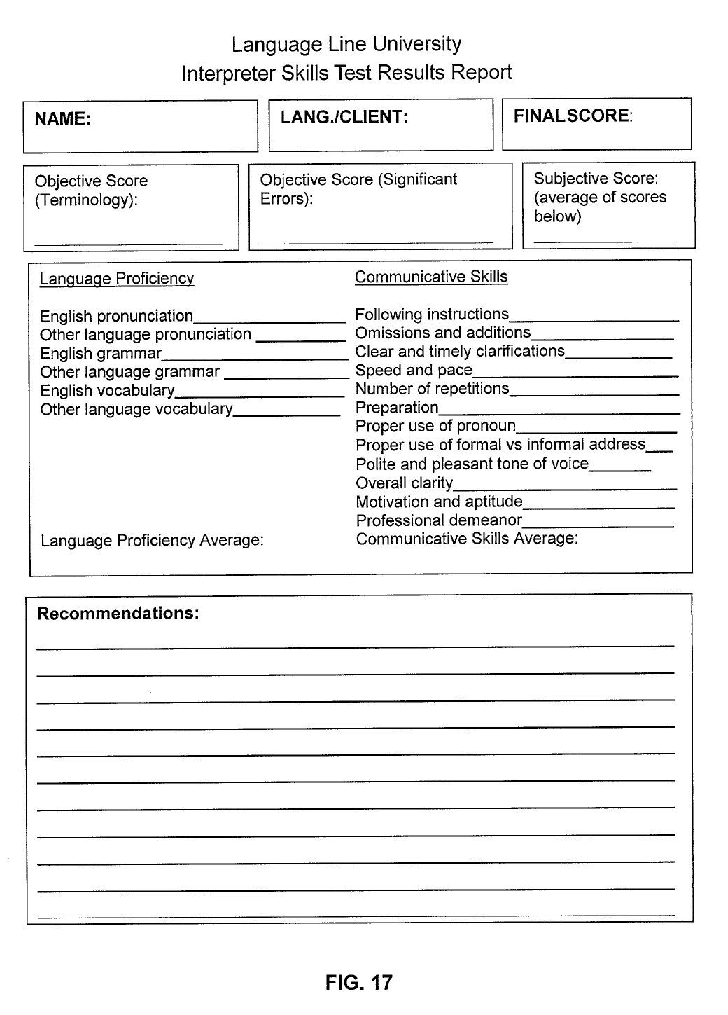

In a preferred embodiment of the present invention, after the rating process is completed, an Interpreter Skills Test Results Report, as illustrated in FIG. 17, is sent to the customer for dissemination to the employee-interpreters who were tested. The customer/client also receives the Recommended Scoring Guidelines, as illustrated in FIG. 16, to aid it in determining the significance of the scoring ranges that applicant uses to determine whether an employee-interpreter “Passed” or “Failed” the test. Based on the test score attained by an employee-interpreter on the certification test, applicant may issue a Certificate of Competency in the employee-interpreter's language pair for the customer's industry. For example, a “Certificate of Competency in Healthcare Interpreting” may preferably be issued to those employee-interpreters who achieve a score of 70% or higher on the exam for their language pair in the healthcare industry. This arrangement embodies herein a method for providing interpretation competency testing services by a business testing at least one customer's actual or potential at least one employee-interpreter comprising the steps of: conducting such interpretation competency testing via telephone with such at least one employee-interpreter by at least one test administrator of such business using at least one interpreter skills test; recording each at least one test source language statement from such interpreter skills test by such test administrator and each at least one corresponding target language response by such employee-interpreter; referencing at least one dictionary comprising scoring units for each such at least one scoring unit contained within such each at least one test source language statement by such test administrator to determine interpretation accuracy of such each at least one corresponding target language response by such employee-interpreter; assigning at least one scoring value for each such target language response by such employee-interpreter reflecting such determined terminology interpretation accuracy; summing a total of such scoring values for each such employee-interpreter for each administration of such interpretation test; calculating at least one terminology score reflecting such employee-interpreter's knowledge of industry-specific terminology; determining language proficiency level of such employee-interpreter by evaluating responses by such employee-interpreter; determining communicative skill level of such employee-interpreters by evaluating responses by such employee-interpreters; assigning at least one subjective score considering such language proficiency level and such communicative skill level demonstrated by such employee-interpreter; and determining such employee-interpreter competency by considering, in combination, such terminology score and subjective score of such employee-interpreter. This arrangement embodies herein further comprising the steps of: contracting with each such customer to provide interpretation competency testing to each such employee-interpreter of such customer; enrolling such customer's employee-interpreters for administration of such interpretation competency testing on a particular date and time; and notifying such employee-interpreter and such customer of such competency determination.

Although applicant has described applicant's preferred embodiments of this invention, it will be understood that the broadest scope of this invention includes such modifications as diverse shapes, sizes and materials. Such scope is limited only by the below claims as read in connection with the above specification. Further, many other advantages of applicant's invention will be apparent to those skilled in the art from the above descriptions and the below claims.

What is claimed is:

1) An interpreter certification process for achieving a defined interpretation competency level in language pairs in industry-specific settings comprising the steps of:
a) selecting interpreters by evaluating language proficiencies and interpretation skills of at least one interpreter candidate in at least one language pair;
b) training at least one such selected interpreter in procedural standards of at least:
i) interpretation,
ii) customer service,
iii) ethics, and
iv) call handling for different industries;
c) training such at least one interpreter in industry-specific terminology in at least one such language pair;
d) setting required minimum competency levels for certification in such at least one language pair in such at least one specific industry; and
e) selecting at least one certified interpreter by testing such at least one interpreter for minimum competency in interpretation in such at least one language pair in such at least one industry-specific setting.

2) The interpreter certification process according to claim 1 further comprising the steps of:
a) documenting such at least one certified interpreter's interpretation performance on at least one interpretation assignment for at least one customer; and
b) documenting such at least one customer's satisfaction level with interpretation performance of such at least one certified interpreter.

3) The method according to claim 1 in which:
a) interpretation is oral consecutive telephone-based interpretation.

4) The method according to claim 1 in which:
a) the specific industry is healthcare.

5) The method according to claim 1 in which:
a) the specific industry is federal, state and local courts.

6) The method according to claim 1 in which:
a) the specific industry is insurance.

7) A test-development method for creating at least one interpretation test to measure interpreter competency in language pairs in industry-specific settings, comprising the steps of:
a) defining of at least one objective for such at least one interpretation test;
b) identifying most-likely interpretation scenarios by surveying actual interpretation instances in at least one industry-specific setting in at least one language pair;
c) identifying most-likely interpretation scenarios by interviewing at least one client in such at least one industry-specific setting for interpretation in such at least one language pair;
d) from such identifications of such most-likely interpretation scenarios, developing, for more uniform scoring, at least one dictionary comprising scoring units providing for essentially each proposed-test source language term a plurality of target language interpretation terms in such at least one industry-specific setting in such at least one language pair;
e) classifying each such target language interpretation term among a desired number of scoring categories based on relative level of interpretation accuracy;
f) constructing, for such at least one language pair, such at least one interpretation test comprising verbal scenarios containing at least a plurality of such source language terms to be interpreted into such target language;
g) administering such at least one interpretation test to a plurality of interpreters;
h) scoring such at least one interpretation test for each such plurality of interpreters using such dictionary comprising scoring units; and
i) for at least each particular target language response on each such at least one interpretation test calling for a non-zero scoring unit and not listed in such dictionary comprising scoring units, determining an appropriate such scoring category to be assigned to such particular response and adding such particular response and category assignment to such dictionary comprising scoring units.

8) The method according to claim 7 wherein such step of, for at least each particular target language response on each such at least one interpretation test calling for a non-zero scoring unit and not listed in such dictionary comprising scoring units, determining an appropriate such scoring category to be assigned to such particular response and adding such particular response and category assignment to such dictionary comprising scoring units, comprises the steps of:
a) assigning at least one expert in such language pair in such industry-specific setting comprising such interpretation test to classify each such target language response not listed in such dictionary comprising scoring units into an appropriate such scoring category based on relative level of interpretation accuracy; and
b) including such classified target language response and such appropriate scoring category in at least one updated version of such dictionary comprising scoring units.

9) The method according to claim 7 further comprising the step of:
a) setting a respective scoring value for each respective such scoring category.

10) The method according to claim 9 wherein such step of, setting a respective scoring value for each respective such scoring category, comprises the steps of:
a) setting a scoring value of two to “most accurate” level of interpretation accuracy;
b) setting a scoring value of one to “accurate” level of interpretation accuracy; and
c) setting a scoring value of zero to “least accurate” level of interpretation accuracy.

11) The method according to claim 7 wherein such step of, scoring such interpretation test for each such plurality of interpreters using such dictionary comprising scoring units, comprises the steps of:
a) summing a total of such scoring values for each such interpreter for each administration of such interpretation test; and
b) presenting such total as a percentage score.

12) The method according to claim 7 further comprising the step of:
a) appointing a team for overseeing development of such interpretation test, wherein such team comprises at least one appointed participant;
b) wherein such at least one appointed participant has recognized expertise in a particular language pair in a particular industry-specific setting; and
c) wherein such appointing is based at least on education and experience.

13) The method according to claim 7 further comprising the steps of:
a) training test administrators using
i) at least one such interpretation test,
ii) at least one test administration guideline, and
iii) at least one test examiner guideline; and
b) validating proficiency measurements for such interpretation test.

14) The method according to claim 7 in which:
a) interpretation is oral consecutive telephone-based interpretation.

15) The method according to claim 7 wherein:
a) such at least one interpretation test is bi-directional.

16) The method according to claim 7 wherein:
a) such at least one interpretation test is uni-directional.

17) The method according to claim 7 in which:
a) the specific industry is healthcare.

18) The method according to claim 7 in which:
a) the specific industry is federal, state and local courts.

19) The method according to claim 7 in which:
a) the specific industry is insurance.

20) A method for administering interpretation tests to interpreters to measure interpreter competency in language pairs in industry-specific settings comprising the steps of:
a) conducting such interpretation tests via telephone with at least one interpreter by at least one test administrator;
b) recording each at least one test source language statement comprising at least one scoring unit by such test administrator and each at least one corresponding target language response by such interpreter;
c) referencing at least one dictionary comprising such scoring units for each such at least one scoring unit contained within such each at least one test source language statement by such test administrator to determine interpretation accuracy of at least one such scoring unit of such each at least one corresponding target language response by such interpreter;
d) assigning at least one scoring value for such each at least scoring unit of such at least one corresponding target language response by such interpreter to reflect such determined interpretation accuracy;
e) summing a total of any such scoring values for each such interpreter for each administration of each such interpretation test;
f) assigning such total as a raw score; and
g) determining such interpreter competency selected essentially from
i) “Meets Standard”,
ii) “Borderline Meets Standard”,
iii) “Does Not Meet Standard”
by comparing such raw score to defined competency score ranges for each such language pair in each such industry-specific setting.

21) The method according the claim 20 further comprising the step of:
a) notifying such interpreter of such competency determination.

22) The method according the claim 20 further comprising the steps of:
a) preparing at least one additional version of such interpretation test to assist preventing pre-knowledge of such interpretation test content by at least one such interpreter;
b) administering such at least one additional version of such interpretation test to interpreters of equivalent skill;
c) noting differences between such additional versions by comparing results of such administrations; and
d) revising such at least one additional version of such interpretation test to achieve essentially comparable measurement of competency.

23) The method according the claim 20 further comprising the step of:
a) for at least each particular target language scoring unit on each such interpretation test calling for a non-zero scoring unit and not listed in such dictionary comprising scoring units, determining an appropriate such scoring value to be assigned to such particular target language scoring unit and adding such particular target language scoring unit and such scoring value to such dictionary comprising scoring units.

24) The method according the claim 23 further comprising the steps of:
a) assigning at least one expert in such language pair in such industry-specific setting comprising such interpretation test to classify each such target language response not listed in such dictionary comprising scoring units into an appropriate such scoring unit based on relative level of interpretation accuracy; and
b) including such classified target language response and such appropriate scoring unit in at least one updated version of such dictionary comprising scoring units.

25) The method according to claim 20 in which:
a) interpretation is oral consecutive telephone-based interpretation.

26) The method according to claim 20 in which:
a) administration of at least one such interpretation test is by strict adherence to a fixed test administration protocol for at least one such interpretation test.

27) The method according to claims 20 wherein:
a) such at least one interpretation test is bi-directional.

28) The method according to claims 20 wherein:
a) such at least one interpretation test is uni-directional.

29) The method according to claim 20 in which:
a) the specific industry is healthcare.

30) The method according to claim 20 in which:
a) the specific industry is federal, state and local courts.

31) The method according to claim 20 in which:
a) the specific industry is insurance.

32) A method for providing interpretation competency testing services by a business testing at least one customer's actual or potential at least one employee-interpreter comprising the steps of:
a) conducting such interpretation competency testing via telephone with such at least one employee-interpreter by at least one test administrator of such business using at least one interpreter skills test;
b) recording each at least one test source language statement from such interpreter skills test by such test administrator and each at least one corresponding target language response by such employee-interpreter;
c) referencing at least one dictionary comprising scoring units for each such at least one scoring unit contained within such each at least one test source language statement by such test administrator to determine interpretation accuracy of such each at least one corresponding target language response by such employee-interpreter;
d) assigning at least one scoring value for each such target language response by such employee-interpreter reflecting such determined terminology interpretation accuracy;
e) summing a total of such scoring values for each such employee-interpreter for each administration of such interpretation test;
f) calculating at least one terminology score reflecting such employee-interpreter's knowledge of industry-specific terminology;
g) determining language proficiency level of such employee-interpreter by evaluating responses by such employee-interpreter;
h) determining communicative skill level of such employee-interpreters by evaluating responses by such employee-interpreters;
i) assigning at least one subjective score considering such language proficiency level and such communicative skill level demonstrated by such employee-interpreter; and
j) determining such employee-interpreter competency by considering, in combination, such terminology score and subjective score of such employee-interpreter.

33) The method according to claim 32 further comprising the steps of:
a) contracting with each such customer to provide interpretation competency testing to each such employee-interpreter of such customer;
b) enrolling such customer's employee-interpreters for administration of such interpretation competency testing on a particular date and time; and
c) notifying such employee-interpreter and such customer of such competency determination.

34) The method according to claim 32 in which:
a) the scoring unit values may be 0, 1 or 2.

35) The method according to claim 32 in which:
a) interpretation is oral consecutive telephone-based interpretation.

36) The method according to claim 32 wherein:
a) such at least one interpretation test is bi-directional.

37) The method according to claim 32 wherein:
a) such at least one interpretation test is uni-directional.

38) The method according to claim 32 in which:
a) the specific industry is healthcare.

39) The method according to claim 32 in which:
a) the specific industry is federal, state and local courts.

40) The method according to claim 32 in which:
a) the specific industry is insurance.

41) A dictionary for scoring of interpretation tests for at least one language pair in at least one industry-specific setting comprising:
a) scoring units structured and arranged to provide, for essentially each source language term of at least one such interpretation test, a plurality of target language interpretation terms in such at least one language pair in such at least one industry-specific setting; and
b) classifications of each such target language interpretation term among a desired number of scoring categories based on determined level of interpretation accuracy.

42) The dictionary according to claim 41 wherein such scoring units are determined from identifications of most-likely interpretation scenarios in such at least one language pair in such at least one industry-specific setting.

43) The dictionary according to claim 41 wherein such scoring categories comprise at least three levels of scoring values.

44) The dictionary according to claim 41 wherein such scoring categories comprise assigned scoring values of:
a) two to “most accurate” level of interpretation accuracy;
b) one to “accurate” level of interpretation accuracy; and
c) zero to “least accurate” level of interpretation accuracy.

45) The dictionary according to claim 41 in which:
a) such interpretation test is oral consecutive telephone-based interpretation test.

46) The dictionary according to claim 41 in which:
a) the specific industry is healthcare.

47) The dictionary according to claim 41 in which:
a) the specific industry is federal, state and local courts.

48) The dictionary according to claim 41 in which:
a) the specific industry is insurance.

49) The method according to claim 1 in which:
a) interpretation is oral consecutive interpretation.

50) The method according to claim 7 in which:
a) interpretation is oral consecutive interpretation.

51) The method according to claim 20 in which:
a) interpretation is oral consecutive interpretation.

52) The method according to claim 32 in which:
a) interpretation is oral consecutive interpretation.

53) The dictionary according to claim 41 in which:
a) such interpretation test is oral consecutive interpretation test.
